(19) United States
(12) Patent Application Publication
(10) Pub. No.: US 2025/0164692 A1
(43) Pub. Date: May 22, 2025

(54) Waveguide Implementations With Adiabatic Structures

(71) Applicant: Xscape Photonics Inc., Fort Lee, NJ (US)

(72) Inventors: Asher Novick, Long Island City, NY (US); Samira Karimelahi, Los Gatos, CA (US); Brian West, Hamilton (CA)

(21) Appl. No.: 18/954,391

(22) Filed: Nov. 20, 2024

Related U.S. Application Data
(60) Provisional application No. 63/600,835, filed on Nov. 20, 2023.

(51) Int. Cl. G02B 6/125; G02B 6/12; G02B 6/126

(52) U.S. Cl. CPC G02B 6/125; G02B 6/126; G02B 2006/12097; G02B 2006/1215; G02B 2006/12159; G02B 2006/12164; G02B 2006/12195

(57) ABSTRACT

Optical waveguides with adiabatic bends (e.g., hybrid partial Euler bends) are described herein. The optical waveguides are implemented into various optical components of integrated photonic devices to improve the performance of the optical components and allow for more compact manufacturing of the integrated photonic devices. In one example, a waveguide having a geometric path defined in a plane and a width perpendicular to the geometric path is described. The geometric path includes an adiabatic curve connecting a first inflection point to a second inflection point on the geometric path, the adiabatic curve including: a circular arc subtending an angle from a first endpoint to a second endpoint; a clothoid connecting the first inflection point to the first endpoint of the circular arc; and an anti-clothoid connecting the second endpoint of the circular arc to the second inflection point.

### CROSS-REFERENCE TO RELATED APPLICATIONS

This application claims the benefit of priority to U.S. Provisional Patent Application No. 63/600,835, titled “WAVEGUIDE IMPLEMENTATIONS WITH ADIABATIC STRUCTURES”, filed on Nov. 20, 2023, which is incorporated by reference herein in its entirety.

### TECHNICAL FIELD

This specification relates generally to waveguide implementations with adiabatic structures.

### BACKGROUND

Silicon photonic devices, e.g., silicon photonic integrated circuits, utilize silicon as an optical transmission medium. Semiconductor fabrication techniques for patterning the silicon photonic devices can achieve sub-micron precision. Since silicon is used as a substrate for most electronic integrated circuits, silicon photonic devices can be hybrid electro-optical devices that integrate both electronic and optical components onto a single microchip. Silicon photonic devices can also be used to facilitate data transfer between microprocessors, a capability of increasing importance in modern networked computing.

### SUMMARY

Optical waveguides with adiabatic bends (e.g., hybrid partial Euler bends), tapers, and other novel geometries are described herein. The optical waveguides are implemented into various optical components of integrated photonic devices to improve the performance of the optical components and/or allow for more compact manufacturing of the of integrated photonic devices. The optical waveguides described herein incorporate an adiabatic bend in which both the curvature and width vary along the geometric path of the optical waveguide. The optical waveguides including such adiabatic bends allow many optical properties to be optimized for a given integrated photonic device, e.g., a silicon photonic device. Such optical properties include, but are not limited to, propagation loss, bending loss, radiation loss, mode mismatch loss, scattering loss, phase matching, polarization dependence, crosstalk, thermal stability, phase error, and dispersion.

Disclosed herein are various integrated photonics applications of the optical waveguides with said adiabatic bends that create novel optical filters, resonant modulators, optical couplers (e.g., directional, edge, and grating couplers), polarization splitter rotators, optical taps, optical multiplexers, optical demultiplexers, and optical Mach-Zehnder Interferometers (MZIs). The integration of the described optical waveguides into these and other optical components leads to precise and accurate splitting of specific amounts of energy and light, filtering of specific wavelengths, exact thermal control and transfer, controlling of polarization states, multiplexing and demultiplexing of wavelengths, and/or controlled transfers of light within and between the optical components.

### BRIEF DESCRIPTION OF THE DRAWINGS

FIG. 1 is a cross-sectional view of an example of an integrated photonic device.

FIG. 2A is a top view of an example of an optical waveguide with an adiabatic bend.

FIG. 2B is a plot depicting an example of a varying curvature and width of an optical waveguide with an adiabatic bend as a function of path length along a geometric path of the optical waveguide.

FIG. 3 is a top view of an example of an optical waveguide with a positive and a negative adiabatic bend.

FIG. 4 is a top view of another example of an optical waveguide with a positive and a negative adiabatic bend.

FIG. 5 is a top view of an example of an optical waveguide with two positive adiabatic bends and a negative adiabatic bend therebetween.

FIGS. 6-1 and 6-2 are top views of an example of two evanescently coupled optical waveguides each of the type shown in FIG. 5.

FIG. 7A is a top view of an example of an optical add-drop filter including a racetrack resonator with two adiabatic bends evanescently coupled to two bus optical waveguides.

FIGS. 7B-7D are cross-sectional views of the racetrack-resonator add-drop filter shown in FIG. 7A with different layer stack configurations.

FIGS. 7E and 7F include plots showing design parameters of optical add-drop filters, such as the racetrack-resonator add-drop filter of FIG. 7A.

FIG. 8A is a top view of another example of an optical add-drop filter including a disk resonator evanescently coupled to two bus optical waveguides with adiabatic bends.

FIGS. 8B-8C are cross-sectional views of the disk-resonator add-drop filter shown in FIG. 8A with different layer stack configurations.

FIG. 9A is a top view of an example of the disk resonator shown in FIG. 8A with a doped heater.

FIG. 9B includes plots showing a spatial distribution of TE0 and TE1 modes versus radius in the doped heater disk resonator shown in FIG. 9A.

FIG. 9C includes a plot of modal spectrum of the doped heater disk resonator shown in FIG. 9A when heat and no heat is applied to the doped heater disk resonator.

FIG. 10 is a top view of another example of an optical add-drop filter including an elliptical disk resonator evanescently coupled to two bus optical waveguides with adiabatic bends.

FIG. 11A is a top view of another example of an optical add-drop filter including a ring resonator evanescently coupled to two bus optical waveguides with adiabatic bends.

FIGS. 11B-11D are cross-sectional views of the ring-resonator add-drop filter shown in FIG. 11A with different layer stack configurations.

FIG. 12A is a top view of an example of a polarization splitter rotator including an input optical waveguide with a tapered section and two output optical waveguides each of the type shown in FIG. 4.

FIG. 12B is a cross-sectional view of the polarization splitter rotator shown in FIG. 12A illustrating a layer stack configuration.

FIG. 13 is a top view of another example of a polarization splitter rotator including two bus optical waveguides with tapered geometries.

FIG. 14A is a top view of an example of an optical tap including two bus optical waveguides with differing widths.

FIG. 14B is a top view of another example of an optical tap including two bus optical waveguides.

FIG. 15 is a top view of another example of an optical tap including an input optical waveguide with a discontinuity and two output optical waveguides each of the type shown in FIG. 4

FIG. 16 is a top view of another example of an optical tap including an input optical waveguide with a discontinuity and two output optical waveguides each of the type shown in FIGS. 2A-2B.

FIG. 17 is a top view of an example of an optical wave-division multiplexing filter including a grated optical waveguide and an input and output optical waveguide each of the type shown in FIG. 4.

FIG. 18A is a top view of an example of an optical Mach-Zehnder Interferometer including two optical waveguides each of the type shown in FIG. 3

FIG. 18B includes a plot of transmission versus wavelength of the Mach-Zehnder Interferometer shown in 18A at two different temperatures.

FIG. 19 a top view of an example of an edge coupler having a multi-stage trident configuration.

### DETAILED DESCRIPTION

### I. Introduction

Photonic integrated circuits (PICs) combine optical components (e.g., waveguides, modulators, and detectors) onto a single photonic chip, similar to how electronic integrated circuits (EICs) integrate electronic components onto a single electronic chip. Integrated photonic devices use light (photons) instead of electrical signals for data transfer and processing, enabling high-speed, high-bandwidth, energy-efficient, and compact systems. Among the various platforms for integrated photonics, silicon photonics has emerged as a leading technology due to its compatibility with existing complementary metal-oxide-semiconductor (CMOS) fabrication processes, enabling large-scale production and cost efficiency.

Integrated photonic devices, particularly silicon photonic devices, offer transformative capabilities across a wide range of applications. In data communication, they enable high-speed optical interconnects, replacing electrical interconnects in data centers and high-performance computing systems, with silicon photonic transceivers integrating lasers, modulators, and detectors to achieve terabit-per-second data rates. In telecommunications, silicon photonics supports long-haul optical transport networks and infrastructure for 5G and beyond. For sensing, silicon photonic biosensors detect biomarkers for disease diagnostics, light detection and ranging (LiDAR) systems enhance autonomous vehicle navigation, and environmental sensors monitor gases or chemicals using on-chip spectrometers. In quantum photonics, integrated photonic devices facilitate quantum computing by manipulating entangled photons and ensure secure communication via quantum key distribution (QKD). Emerging in artificial intelligence (AI) and neuromorphic computing, silicon photonics powers photonic neural networks for ultra-fast, parallel data processing. In medical imaging, photonic chips enable compact, high-resolution optical coherence tomography (OCT) systems. Finally, aerospace and defense applications include robust and lightweight photonic systems for secure satellite communication, advanced optical gyroscopes for precision navigation, and enhanced defense networks. With these diverse applications, silicon photonics is driving innovation across industries.

However, trapping and confining photons in PICs is challenging due to their wave nature and the need to precisely control their propagation. Photons are waves, so they inherently spread out via diffraction when propagating, especially in regions with sharp bends or abrupt changes in the waveguide geometry. Maintaining confinement relies on total internal reflection or mode confinement, which depends on the refractive index contrast between the waveguide core and cladding. Insufficient contrast or sharp transitions can lead to scattering and photon loss into undesired directions. Furthermore, tight bends in photonic circuits cause significant radiation losses as the optical mode cannot remain confined and leaks out. This is exacerbated by the fact that a portion of the photon's energy resides in the evanescent field, which extends outside the waveguide core and can couple to unintended modes or structures. Additionally, sharp corners or abrupt geometry changes result in reflection and scattering of light, further reducing confinement efficiency.

The adiabatic bends and structures described herein are a solution to these abovementioned challenges as they mitigate losses through gradual transitions in waveguide geometry. The adiabatic bends enable smooth mode transitions by slowly varying the waveguide shape, allowing the optical mode to adapt without significant distortion, thereby minimizing scattering and radiation losses. Instead of forcing light into a sharp curve, the adiabatic bends use gradual curvature and width changes to maintain the optical mode's confinement within the waveguide, which is particularly beneficial for high-index-contrast materials like silicon photonics. Adiabatic bends also preserve the quality of the optical mode, preventing deformation or coupling into higher-order modes during the transition. Furthermore, their gradual design ensures efficient operation across a broad wavelength range, making them suitable for applications like wavelength-division multiplexing (WDM). The adiabatic bends are also robust to fabrication imperfections, as the smooth transitions reduce the impact of small variations in the waveguide geometry. These properties make the adiabatic bends invaluable for compact routing, where they minimize losses in tight waveguide layouts, and for low-loss interconnects in photonic circuits. The adiabatic bends can be a key element for high-quality (high-Q) resonators, e.g., racetrack, disk, and ring resonators, by reducing bending losses and ensuring precise confinement of light. The robustness to fabrication imperfections the adiabatic bends introduce also improves the optical components constructed out of them and the overall device performance reliability.

To demonstrate the numerous applications of the adiabatic bends, this specification discloses various integrated photonics devices including one or more optical waveguides with said adiabatic bends. The incorporation of such waveguides creates novel optical filters, resonant modulators, optical couplers (e.g., directional, edge, and grating couplers), polarization splitter rotators, optical taps, optical multiplexers, optical demultiplexers, and optical Mach-Zehnder Interferometers (MZIs). For example, the integration of the described optical waveguides into these and other optical components leads to precise and accurate splitting of specific amounts of energy and light, filtering of specific wavelengths, exact thermal control and transfer, controlling of polarization states, multiplexing and demultiplexing of wavelengths, and/or controlled transfers of light within and between the optical components.

Note, the term “evanescent coupling” is used herein to describe the coupling between two optical components. In general, an evanescent field is an oscillating electromagnetic field that exists in the immediate vicinity of a source, such as an interface between two different media but decays exponentially with distance from the source. Evanescent coupling occurs when two optical devices are brought close enough that the evanescent fields of one overlap with the other, allowing energy to transfer between the two without direct physical contact. Distances between the two optical components typically range from about λ/10 to λ/2 depending on the design and size of the components. Here, λ is the wavelength of the electromagnetic fields and ranges from about 1260 nanometers (nm) to 1625 nm in the telecommunications regime. Hence, distances (referred to as coupling spacings) between two evanescently coupled optical components is typically on the order of hundreds of nanometers for strong coupling and microns for moderate or weak coupling.

These features and other features are described in more detail below.

### II. Examples of Integrated Photonic Devices

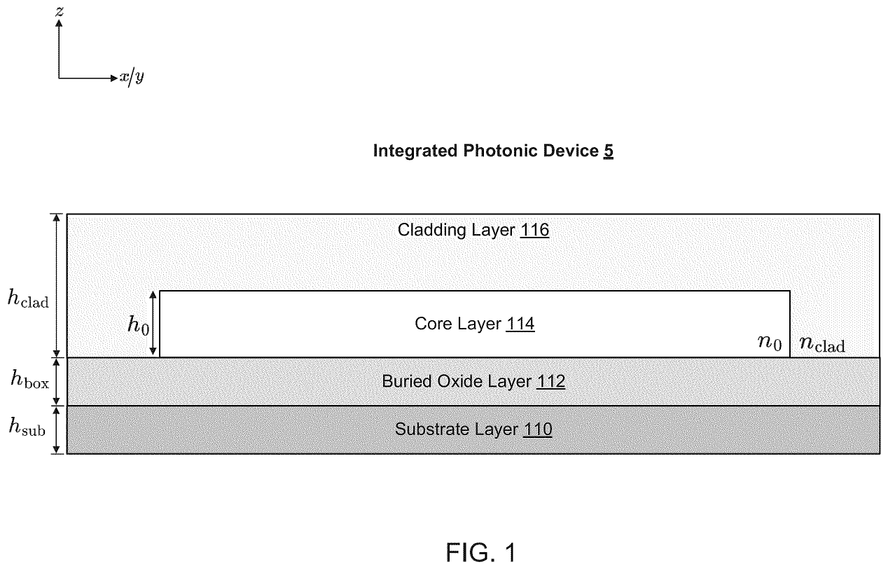

FIG. 1 is a cross-sectional view of an example of an integrated photonic device 5, e.g., a silicon integrated photonic device. The integrated photonic device 5 can be a single, functional component in a larger PIC. The integrated photonic device 5 can also be a standalone optical chip that includes multiple interconnected optical components that together perform a specific function. Numerous examples of the integrated photonic device 5 that utilize optical waveguides with one or more adiabatic bends 10 are described herein, including optical filters (and resonant modulators) 100, polarization splitter rotators (PSRs) 200, optical taps 300, optical wave-division multiplexing (WDM) filters 400, and optical Mach-Zehnder Interferometers (MZIs) 500. Each of which can be realized as a part or whole of the integrated photonic device 5.

The integrated photonic device 5 can be configured to operate over a desired optical wavelength range including, but not limited to, the Original (“O”) Band from 1260 nanometers (nm) to 1360 nm; the Extended (“E”) Band from 1350 nm to 1360 nm; the Short Wavelength (“S”) Band from 1460 nm to 1530 nm; the Conventional (“C”) band from 1530 nm to 1565 nm; the Long Wavelength (“L”) Band from 1565 nm to 1625 nm; or the Ultra-Long Wavelength (“U”) Band from 1625 nm to 1675 nm; or any combination thereof. These optical bands are widely used in data communications and telecommunications due to low optical loss in standard silica optical fibers and the availability of efficient erbium-doped fiber amplifiers (EDFA) for the C- and L-bands.

As shown in FIG. 1, the integrated photonic device 5 includes a substrate layer 110, a buried oxide layer 112, a core layer 114, and a cladding layer 116 stacked on top of one another. In general, the integrated photonic device 5 and optical components integrated therein are planar (aka two-dimensional) such that light propagates in the x-y plane and is confined by total internal reflection along the orthogonal z-axis.

The substrate layer 110 of the integrated photonic device 5 serves as the foundational material that supports the other layers 112, 114, and 116 and influences optical, thermal, and mechanical properties of the integrated photonic device 5. The choice of material for the substrate layer 110 depends on the specific application and fabrication technology. For example, the substrate layer 110 can be composed of silicon, silicon dioxide, silicon carbide, sapphire, indium phosphide, gallium arsenide, lithium niobate, glass (e.g., silica, or a borosilicate), or a polymer (e.g., a polyimide). The substrate layer 110 can have a thickness (h_{sub}) in a range from about 100 microns (μm) to 1,000 μm. For example, the substrate layer 110 can have a thickness of at least about 100 μm, 200 μm, 300 μm, 400 μm, 500 μm, 600 μm, 700 μm, 800 μm, 900 μm, 1,000 μm, or more. The substrate layer 110 can have a thickness of at most about 1,000 μm, 900 μm, 800 μm, 700 μm, 600 μm, 500 μm, 400 μm, 300 μm, 200 μm, 100 μm, or less.

The buried oxide (or “BOX”) layer 112 is disposed on the substrate layer 110. The buried oxide layer 112 of the integrated photonic device 5 isolates the core layer 114 from the substrate layer 110. The buried oxide layer 112 can provide optical isolation via refractive index contrast and electrical insulation between the core layer 114 and the substrate layer 110. The buried oxide layer 112 is most commonly used in silicon-on-insulator (SOI) implementations of the integrated photonic device 5. In these cases, the buried oxide layer 112 can be composed of silicon dioxide.

More generally, the buried oxide layer 112 can be a dielectric layer composed of a suitable electrically insulating material. For example, the buried oxide layer 112 can also be composed of silicon nitride, aluminum oxide, or a polymer (e.g., polymethyl methacrylate (PMMA), SU-8, or a polyimide). Alternatively, an air gap can be used in place of the buried oxide layer 112, e.g., an air cladding layer. The buried oxide layer 112 can have a thickness (h_{box}) in a range from about 100 nm to 5 μm. For example, the buried oxide layer 112 can have a thickness of at least about 100 nm, 200 nm, 300 nm, 400 nm, 500 nm, 600 nm, 700 nm, 800 nm, 900 nm, 1 μm, 2 μm, 3 μm, 4 μm, 5 μm, or more. The buried oxide layer 112 can have thickness of at most about 5 μm, 4 μm, 3 μm, 2 μm, 1 μm, 900 nm, 800 nm, 700 nm, 600 nm, 500 nm, 400 nm, 300 nm, 200 nm, 100 nm, or less.

The core layer 114 is disposed on the buried oxide layer 112. The core layer 114 of the integrated photonic device 5 is the region where light is confined and propagates. The optical components of the integrated photonic device 5 are formed in the core layer 114, see Sections III-IX for examples of such optical components. Thus, the choice of material for the core layer 114 can significantly influence the optical properties of the integrated photonic device 5, such as mode confinement, propagation loss, and wavelength compatibility. For example, the core layer 114 can be composed of silicon, silicon nitride, silicon carbide, indium phosphide, gallium arsenide, aluminum gallium arsenide, lithium niobate, titanium-diffused lithium niobate, a chalcogenide glass, glass (e.g., silica, or a borosilicate), or a III-V semiconductor alloy (e.g., gallium nitride, aluminum gallium indium phosphide, or aluminum gallium indium arsenide). The core layer 114 can have a thickness (h₀) in a range from about 100 nm to 500 nm. For example, the core layer 114 can have a thickness of at least about 100 nm, 150 nm, 200 nm, 250 nm, 300 nm, 350 nm, 400 nm, 450 nm, 500 nm, or more. The core layer 114 can have a thickness at most about 500 nm, 450 nm, 400 nm, 350 nm, 300 nm, 250 nm, 200 nm, 150 nm, 100 nm, or less. As a few particular examples, the core layer 114 can have a thickness of 220 nm or 340 nm. The core layer 114 can have a refractive index (n₀) in a range from about 1.25 to 3.50. For example, the core layer 114 can have a refractive index of at least about 1.25, 1.50, 1.75, 2.00, 2.25, 2.50, 2.75, 3.00, 3.25, 3.50, or more. The core layer 114 can have a refractive index of at most about 3.50, 3.25, 3.00, 2.75, 2.50, 2.25, 2.00, 1.75, 1.50, 1.25, or less.

The cladding layer 116 is disposed on the buried oxide layer 112 and the core layer 114, thereby surrounding each exposed surface of the core layer 114. The cladding layer 116 of the integrated photonic device 5 confines light within the core layer 114 by creating a refractive index contrast therebetween. The choice of material for the cladding layer 116 can depend on the material of the core layer 116, the operating wavelength, and the intended application of the integrated photonic device 5. For example, the cladding layer 116 can be composed of silicon dioxide, silicon nitride, oxynitride, a chalcogenide glass, glass (e.g., silica, or a borosilicate), a polymer (e.g., PMMA, SU-8, or a polyimide), or a perfluorinated polymer. Alternatively, an air gap can be used in place of the cladding layer 116, e.g., an air cladding layer. The cladding layer 116 can have a thickness (h_{clad}) in a range from about 1 μm to 20 μm. For example, the cladding layer 116 can have a thickness of at least about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, or more. The cladding layer 116 can have a thickness of at most about 20 μm, 19 μm, 18 μm, 17 μm, 16 μm, 15 μm, 14 μm, 13 μm, 12 μm, 11 μm, 10 μm, 9 μm, 8 μm, 7 μm, 6 μm, 5 μm, 4 μm, 3 μm, 2 μm, 1 μm, or less. The cladding layer 116 can have a refractive index (n_{clad}) in a range from about 1.00 to 3.00. For example, the cladding layer 116 can have a refractive index of at least about 1.00, 1.25, 1.50, 1.75, 2.00, 2.25, 2.50, 2.75, 3.00, or more. The cladding layer 116 can have a refractive index of at most about 3.00, 2.75, 2.50, 2.25, 2.00, 1.75, 1.50, 1.25, 1.00, or less. In most cases, the refractive index of the cladding layer 116 is less than the refractive index of the core layer 114, i.e., n_{clad}<n₀, to provide the refractive index contrast noted above. This is not a necessary condition however, as optical confinement can be achieved in a low-index core, through mechanisms such as a slot waveguide, a Bragg reflection cladding, an anti-resonant reflecting optical waveguide (ARROW), or through plasmonic waveguiding.

In some implementations, the photonic integrated device 5 can also include a ridge layer 115 disposed on the buried oxide layer 112, surrounding or beside at least a portion of the core layer 114. The ridge layer 115 of the integrated photonic device 5 can be electrically active (intrinsically or doped), serving as an electrode layer that can be used to apply electric fields to modulate, switch, or otherwise tune the optical components of the core layer 114 and/or properties of optical signals propagating within the core layer 114. Alternatively, or in addition, the ridge layer 115 can serve as a heater and/or thermal control layer to alter the properties of the core layer 114 via its thermo-optic coefficient (TOC) and/or resistive (Ohmic) heating. Note, when configured as an electrode or heater layer, the ridge layer 115 may also be disposed on a portion of the core layer 114 that is being electrically or thermally controlled. Example implementations of the ridge layer 115 are described in greater detail below. The choice of material for the ridge layer 115 depends on the functionality, fabrication constraints, and performance requirements of photonic integrated device 5, such as conductivity, compatibility, and optical transparency. For example, the ridge layer 115 can be composed of the same material as the core layer 114 if the core layer 114 is a semiconductor. In these cases, the ridge layer 115 can be fabricated as a part of the core layer 114 from the same semiconductor wafer, e.g., a silicon wafer. More generally, the ridge layer 115 can be composed of a metal (e.g., gold, silver, aluminum, copper, or platinum), a transparent conductive oxide (e.g., indium tin oxide, aluminum-doped zinc oxide, or fluorine-doped tin oxide), an alloy (e.g., titanium nitride, nickel-chromium, or gold-titanium), a two-dimensional conductive material (e.g., graphene), or a doped semiconductor (e.g., doped silicon or doped indium phosphine). The ridge layer 115 can have a thickness (hₘ) in a range from about 100 nm to 500 nm. For example, the ridge layer 115 can have a thickness of at least about 100 nm, 150 nm, 200 nm, 250 nm, 300 nm, 350 nm, 400 nm, 450 nm, 500 nm, or more. The ridge layer 115 can have a thickness at most about 500 nm, 450 nm, 400 nm, 350 nm, 300 nm, 250 nm, 200 nm, 150 nm, 100 nm, or less. As one example, the ridge layer 115 can have a smaller thickness than the core layer 114, i.e., hₘ<h₀. As another example, the ridge layer 115 can have half the thickness as the core layer 114, i.e., hₘ=h₀/2. As a few particular examples, the ridge layer 115 can have a thickness of 110 nm or 170 nm.

In some implementations, the photonic integrated device 5 can also include an encapsulation layer disposed on the cladding layer 116. The encapsulation layer serves as a passivation layer on top of the photonic integrated device 5 to protect the structure and optical components of the photonic integrated device 5 from environmental factors such as moisture and contamination. For example, the encapsulation layer can be composed of a polymer (e.g., PMMA, SU-8, or a polyimide), a perfluorinated polymer, an epoxy-based material, glass (e.g., silica, or a borosilicate), a chalcogenide glass, silicon dioxide, silicon nitride, aluminum oxide, a hydrophobic coating, or an anti-reflective coating. The encapsulation layer can have a thickness in a range from about 100 nm to 20 μm. For example, the encapsulation layer can have a thickness of at least about 100 nm, 200 nm, 300 nm, 400 nm, 500 nm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, or more. The encapsulation layer can have a thickness of at most about 20 μm, 19 μm, 18 μm, 17 μm, 16 μm, 15 μm, 14 μm, 13 μm, 12 μm, 11 μm, 10 μm, 9 μm, 8 μm, 7 μm, 6 μm, 5 μm, 4 μm, 3 μm, 2 μm, 1 μm, 500 nm, 400 nm, 300 nm, 200 nm, 100 nm, or less.

### III. Examples of Optical Waveguides with Adiabatic Bends

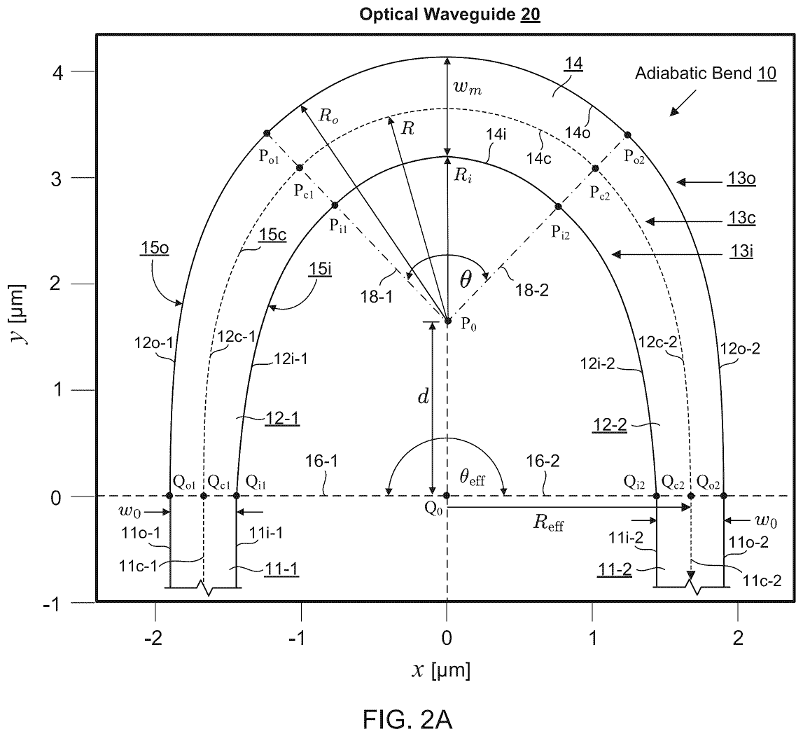

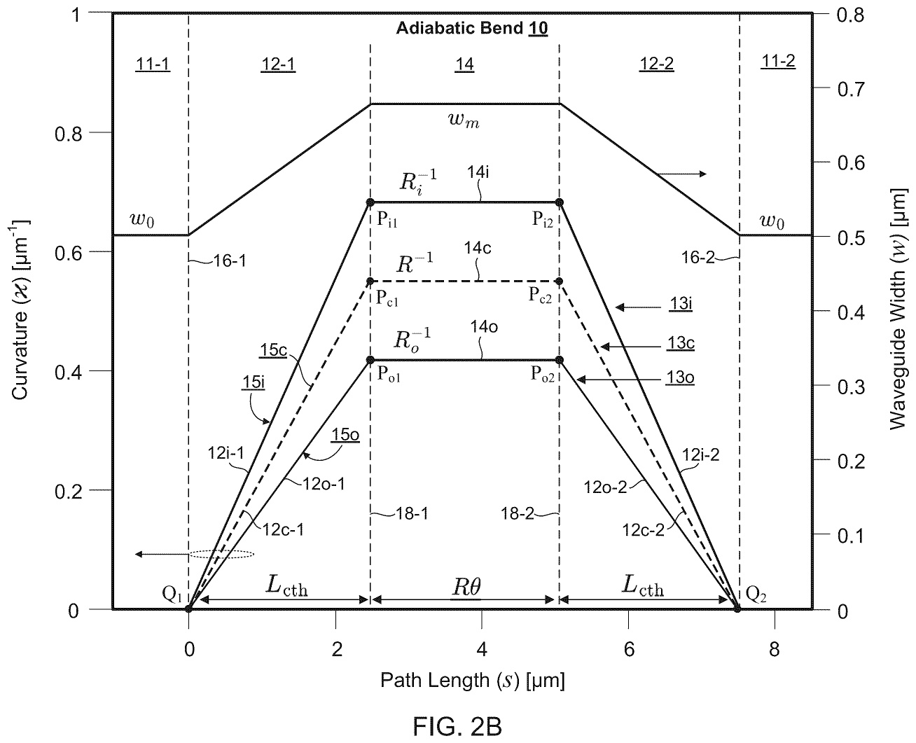

FIG. 2A is a top view of an example of an optical waveguide 20 with an adiabatic bend 10. FIG. 2B is a plot depicting an example of a varying curvature and width of the optical 20 waveguide within the adiabatic bend 10 as a function of path length along a geometric path 15c of the optical waveguide 20. For ease of description, reference will be made to both FIGS. 2A and 2B when describing the detailed structure and operation of the optical waveguide 20.

The adiabatic bend 10 is a specially designed waveguide bend that can be used in integrated photonics to address several challenges related to light propagation through curved or looped optical waveguides. The adiabatic bend 10 may also be referred to as a “hybrid partial Euler bend” as it can be understood as a partial Euler bend with a varying width.

The adiabatic bend 10 can be implemented in an optical waveguide to minimize optical losses and maintain mode integrity by ensuring smooth transitions of an optical mode as it traverses the adiabatic bend 10. The adiabatic bend 10 reduces bending losses by providing smooth curvature and width transitions, ensuring the optical mode remains well-confined while minimizing radiation loss even with exceeding tight bending angles and bending radii. The adiabatic bend 10 can also mitigate mode mismatch, which prevents the excitation of higher-order or radiation modes and preserves the integrity of the confined optical mode. By improving mode confinement, the adiabatic bend 10 can be implemented to reduce crosstalk between closely spaced waveguides in densely packed photonic integrated circuits.

The adiabatic bend 10 enables compact designs by facilitating smaller bending radii without sacrificing efficiency, saving valuable chip space. The smoothly varying curvature and width of the adiabatic bend 10 also enhances fabrication tolerance, reducing sensitivity to imperfections such as sidewall roughness or non-uniform etching. Additionally, the adiabatic bend 10 can help distribute the optical field more evenly, improving optical power handling and reducing the risk of localized field damage or nonlinear effects. The adiabatic bend 10 can be implemented to enhance the performance of advanced photonic devices like resonator filters 100 by improving Q-factors, polarization splitter rotators 200 by increasing polarization conversion efficiency, optical taps 300 and coupled waveguides by improving phase matching and flattening the wavelength spectrum, WDM filters 400 by reducing scattering losses, and MZIs 500 by providing precise phase and thermal control.

As one example, the adiabatic bend 10 can be a compact single-mode waveguide bend, ubiquitous for routing and substructures of more complex compound device geometries. As another example, the adiabatic bend 10 can be a compact multi-mode waveguide bend that maintains mode orthogonality, thereby providing a fabrication robust waveguide platform, e.g., (only TE0 mode)+mode division multiplexing (all supported modes). In either case, the design of the adiabatic bend 10 can be carried out using analytical solutions or optimization algorithms, such as particle swam optimization or adjoint method parametric inverse design to determine the curvature, width, and radius variations for a given application. Hence, the adiabatic bend 10 can be a key element for compact, efficient, and high-performance photonic integrated circuits in applications such as telecommunications, quantum photonics, and sensing.

As shown in FIGS. 2A-2B, the optical waveguide 20 has a geometric path 15c, a first profile 15i (e.g., an inner profile), and a second profile 15o (e.g., an outer profile). The first 15i and second 15o profiles are surfaces of the optical waveguide 20 that extend in the z-direction to a top surface of the core layer 114. The optical waveguide 20 has a fixed, operational height (h₀) from the x-y plane, corresponding to the thickness of the core layer 114. The geometric path 15c defines the physical path of the optical waveguide 20 within the x-y plane, while the first 15i and second 15o profiles define the boundary of the optical waveguide 20 in the x-y plane. Particularly, the geometric path 15c is the centerline of the optical waveguide 20 such that each point along the geometric path 15c is a respective midpoint of the optical waveguide 20 between the first 15i and second 15o profiles. The width (w) of the optical waveguide 20, referred to as the “normal width”, is perpendicular to the geometric path 15c and defines the distance between the first 15i and second 15o profiles at each point along the geometric path 15c. How the normal width and midpoint of the optical waveguide 20 are unambiguously defined for curved geometries is discussed in further detail below.

The optical waveguide 20 includes a first linear section 11-1, an adiabatic bend 10, and a second linear section 11-2 that are serially connected one another. Each of the first linear section 11-1, adiabatic bend 10, and second linear section 11-2 are defined by particular line segments and curves of the first 15i and second 15o profiles relative the geometric path 15c.

The normal width of the optical waveguide 20 is equal to an operation width (w₀) within the first 11-1 and second 12-2 linear sections. Moreover, the curvature of the optical waveguide 20 is zero within the first 11-1 and second 12-2 linear sections. In some implementations, the optical waveguide 20 can have an operational width in a range from about 200 nm to 600 nm. For example, the optical waveguide 20 can have an operational width of at least about 200 nm, 250 nm, 300 nm, 350 nm, 400 nm, 450 nm, 500 nm, 550 nm, 600 nm, or more. The optical waveguide 20 can have an operational width of at most about 600 nm, 550 nm, 500 nm, 450 nm, 400 nm, 350 nm, 300 nm, 250 nm, 200 nm, or less.

The adiabatic bend 10 includes a Euler section 12-1, an arcuate section 14, and an anti-Euler section 12-2 serially connected to one another. The curvature and normal width of the optical waveguide 20 both vary within the adiabatic bend 10. The adiabatic bend 10 has an effective bending angle (θ_{eff}) that defines the total angle subtended by the optical waveguide 20 over the adiabatic bend 10, about an effective conformal point (Q₀) in the x-y plane. The adiabatic bend 10 also has an effective bending radius (R_{eff}) that defines the total radial distance traversed by the optical waveguide 20 over the adiabatic bend 10. In some implementations, the effective bending angle is in a range from 0<θ_{eff}≤π, for example, a range from about 1 degree to 180 degrees. As a few particular examples, the effective bending angle can be 45 degrees, 90 degrees, 135 degrees, 180 degrees, or 225 degrees. For a 90-degree effective bending angle, the first 11-1 and second 11-2 linear sections are orthogonal to each other. For a 180-degree effective bending angle, the first 11-1 and second 11-2 linear sections are parallel to each other. In some implementations, the effective bending radius is in a range from about 1 μm to 50 μm. For example, the effective bending radius can be at least about 1 μm, 2 μm, 3 μm, 4 μm, 5 μm, 6 μm, 7 μm, 8 μm, 9 μm, 10 μm, 20 μm, 30 μm, 40 μm, 50 μm, or more. The effective bending radius can be at most about 50 μm, 40 μm, 30 μm, 20 μm, 10 μm, 9 μm, 8 μm, 7 μm, 6 μm, 5 μm, 4 μm, 3 μm, 2 μm, 1 μm, or less.

Within the arcuate section 14 of the adiabatic bend 10, the normal width of the optical waveguide 20 is equal to an auxiliary width (wₘ), and the curvature of the optical waveguide 20 is a positive constant. In some implementations, the optical waveguide 20 can have an auxiliary width in a range from about 250 nm to 750 nm. For example, the optical waveguide 20 can have an auxiliary width of at least about 250 nm, 300 nm, 350 nm, 400 nm, 450 nm, 500 nm, 550 nm, 600 nm, 650 nm, 700 nm, 750 nm, or more. The optical waveguide 20 can have an operational width of at most about 750 nm, 700 nm, 650 nm, 600 nm, 550 nm, 500 nm, 450 nm, 400 nm, 350 nm, 300 nm, 250 nm, or less.

The arcuate section 14 has a conformal angle (θ) that defines the angle subtended by the optical waveguide 20 over the arcuate section 14, about a conformal point (P₀) in the x-y plane. The conformal point is measured a distance of d from the effective conformal point along a bisecting line of the adiabatic bend 10, which is typically set by the other parameters of the adiabatic bend 10. The conformal angle of the arcuate section 14 is related to the effective bending angle of the adiabatic bend 10 as θ=(1−p)θ_{eff}, where 0<p<1 is a bend parameter. The arcuate section 14 also has a radius (R) that defines the radial distance traversed by the optical waveguide 20 over the arcuate section 14. In some implementations, the radius of the arcuate section 14 is in a range from about 0.5 μm to 10 μm. For example, the radius of the arcuate section 14 can be at least about 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, or more. The radius of the arcuate section 14 can be at most about 10 μm, 9 μm, 8 μm, 7 μm, 6 μm, 5 μm, 4 μm, 3 μm, 2 μm, 1 μm, 0.9 μm, 0.8 μm, 0.7 μm, 0.6 μm, 0.5 μm, or less.

Within the Euler section 12-1 of the adiabatic bend 10, the normal width of the optical waveguide 20 increases linearly from the operational width to the auxiliary width, and the curvature of the optical waveguide 20 increases linearly from zero curvature to the positive curvature of the arcuate section 14. Similarly, within the anti-Euler section 12-2 of the adiabatic bend 10, the normal width of the optical waveguide 20 decreases linearly from the auxiliary width to the operational width, and the curvature of the optical waveguide 20 decreases linearly from the positive curvature of the arcuate section 14 to zero curvature.

Referring now to the geometry of the geometric path 15c, first profile 15i, and second profile 15o of the optical waveguide 20.

The geometric path 15c of the optical waveguide 20, represented as [symbol] =(x, y), is defined in the x-y plane and can be parametrized as [symbol] = [symbol] (s), where s is the length of the geometric path [symbol] 15, i.e., the path length, specified with some interval. The arrowhead at the end of the geometric path 15c indicates the direction of the path length parametrization.

The tangent vector [symbol] (s) at each point along the geometric path 15c is the derivative of the geometric path 15c with respect to the path length:

$$\vec{t} ( s ) = {\vec{r}}^{′} ( s ) = ( \frac{d x}{d s} , \frac{d y}{d s} ) = ( {x}^{′} , {y}^{′} ) . \qquad ( 1 )$$

The curvature (κ) at each point along the geometric path 15c is the magnitude of the derivative of the tangent vector with respect to the path length:

$$κ ( s ) = ‖ {\vec{t}}^{′} ( s ) ‖ = ‖ {\vec{r}}^{″} ( s ) ‖ = \sqrt{{( {x}^{″} )}^{2} + {( {y}^{″} )}^{2}} . \qquad ( 2 )$$

In other words, the curvature is the magnitude of the second derivative of the geometric path 15c with respective to the path length. The inverse of the curvature at each point provides the radius of curvature ( [symbol] ) at that point [symbol] (s)=κ⁻¹(s). Moreover, the normal vector \vec{n}(s)=(y′, −x′) at each point along the geometric path 15c is perpendicular to the tangent vector at that point [symbol] (s)· [symbol] (s)=0. Here, for ease of description, the normal vector is defined as a

$$\frac{π}{2}$$

clockwise rotation of the tangent vector in the x-y plane.

The normalized normal vector

$$\hat{n} ( s ) = \frac{\vec{n} ( s )}{‖ \vec{t} ( s ) ‖}$$

is related to the derivate of the tangent vector as [symbol] (s)=k(s)\hat{n}(s), where k(s)=±κ(S) is the oriented curvature (or signed curvature). The oriented curvature depends on both the orientation of the x-y plane (definition of clockwise), and the parametrization of the geometric path 15c within the x-y plane. Hence, the choice of positive and negative curvature is generally arbitrary as they are defined relative to each other. As used herein, clockwise will refer to the positive azimuthal direction and counterclockwise will refer to the negative azimuthal direction, which defines positive and negative curvature with respect to the normal vector and parametrization of the geometric path 15c.

At each point along the geometric path 15c, the normal vector n(s) of the geometric path 15c intersects the first profile 15i at a respective first point \vec{r}ᵢ(s) in the x-y plane, while the anti-normal vector −\vec{n}(s) of the geometric path 15c intersects the second profile 15i at a respective second point \vec{r}ₒ(s) in the x-y plane. The paths r̅ᵢ(s) and r̅ₒ(s) provide a parametrization of the first 15i and second 15o profiles, respectively, in terms of the path length of the geometric path 15c. The normal width of the optical waveguide 20, in vector form, is the displacement between the respective paths \vec{r}ᵢ(s) and \vec{r}ₒ(s) of the first 15i and second 15o profiles:

$$\vec{w} ( s ) = {\vec{r}}_{i} ( s ) - {\vec{r}}_{o} ( s ) . \qquad ( 3 )$$

Thus, the normal width of the optical waveguide 20 is parallel to the normal vector of the geometric path 15c, or equivalently, perpendicular to the tangent vector of the geometric path 15c. Equation (3) provides a parametrization of the normal width of the optical waveguide 20 in terms of the path length of the geometric path 15c. As a result, the normal width of the optical waveguide 20 has a magnitude equal to the distance between first 15i and second 15o profiles:

$$w ( s ) = ‖ {\vec{r}}_{i} ( s ) - {\vec{r}}_{o} ( s ) ‖ . \qquad ( 4 )$$

Furthermore, as each point along the geometric path 15c is defined as a respective midpoint between the first 15i and second 15o profiles, the following condition is also self-consistently satisfied:

$$w ( s ) = 2 ‖ {\vec{r}}_{i} ( s ) - \vec{r} ( s ) ‖ = 2 ‖ {\vec{r}}_{o} ( s ) - \vec{r} ( s ) ‖ . \qquad ( 5 )$$

In other words, the distance from the geometric path 15c to the first profile 15i is equal to the distance from the geometric path 15c to the second profile 15o at each point along the geometric path 15c.

The geometric structure of the geometric path 15c, first profile 15i, and second profile 15o of the optical waveguide 20 will now be described in detail using the above parametrization.

Referring first to the geometric path 15c of the optical waveguide 20. The geometric path 15c, parametrized as [symbol] (s), includes a first line segment 11c-1, an adiabatic curve 13c, and a second line segment 11c-2 serially connected to one another. The first line segment 11c-1 has zero curvature and extends to a first inflection point (Q_{c1}) on the geometric path 15c. The second line segment 11c-2 also has zero curvature and extends from a second infection point (Q_{c2}) on the geometric path 15c. The curvature of the geometric path 15c is instantaneously zero at each of its first and second inflection points.

The adiabatic curve 13c includes a clothoid 12c-1, a circular arc 14c, and an anti-clothoid 12c-2 serially connected to one another. The adiabatic curve 13c is a differentiable curve that connects the first inflection point on the geometric path 15c to the second inflection point on the geometric path 15c. The adiabatic curve 13c has continuous curvature between the first and second inflection points of the geometric path 15c, thus, the geometric path 15c can be at least twice differentiable at each point. The adiabatic curve 13c subtends the effective bending angle (θ_{eff}) of the adiabatic bend 10 in the positive azimuthal direction about the effective conformal point (Q₀) in the x-y plane. The effective bending radius (R_{eff}) of the adiabatic bend 10 is measured from the effective conformal point to each of the first and second inflection points on the geometric path 15c.

The circular arc 14c subtends the conformal angle (θ) about the conformal point (P₀) in the x-y plane. The circular arc 14c has a first endpoint (P_{c1}) and a second endpoint (P_{c2}) on the geometric path 15c and subtends the conformal angle in the positive azimuthal direction. The circular arc 14c has a radius of R from the conformal point, an arc length of RB between its first and second points, and a constant curvature of R⁻¹.

The clothoid 12c-1, also referred to as a Euler spiral, connects the first inflection point on the geometric path 15c to the first endpoint of the circular arc 14c. The curvature of the clothoid 12c-1 increases linearly with the path length

$$κ ( s ) = \frac{{R}^{- 1} s}{{L}_{cth}} ,$$

from zero curvature at the first inflection point on the geometric path 15c to the curvature R⁻¹ of the circular arc 14c at its first endpoint. Consequently, the clothoid 12c-1 is an osculating curve connecting the first inflection point on the geometric path 15c to the first endpoint of the circular arc 14c.

Similarly, the anti-clothoid 12c-2, also referred to as an anti-Euler spiral, connects the second endpoint of the circular arc 14c to the second inflection point on the geometric path 15c. The curvature of the anti-clothoid 12c-2 decreases linearly with the path length

$$κ ( s ) = {R}^{- 1} - \frac{{R}^{- 1} s}{{L}_{cth}} ,$$

from the curvature R⁻¹ of the circular arc 14c at its second endpoint to zero curvature at the second inflection point on the geometric path 15c. Consequently, the anti-clothoid 12c-2 is an anti-osculating curve connecting the second endpoint of the circular arc 14c to the second inflection point on the geometric path 15c.

The clothoid 12c-1 has a length of L_{cth} between the first inflection point on the geometric path 15c and the first endpoint of the circular arc 14c. The anti-clothoid 12c-2 has the same length of L_{cth} between the second endpoint of the circular arc 14c and the second inflection point on the geometric path 15c. In general, the length of the clothoid 12c-1 and anti-clothoid 12c-2 determine the rate of change of the curvature and width of the optical waveguide 20 within the Euler 12-1 and anti-Euler 12-2 sections. In some implementations, the length of the clothoid 12c-1 and anti-clothoid 12c-2 is in a range from about 1 μm to 20 μm. For example, the length of the clothoid 12c-1 and anti-clothoid 12c-2 can be at least about 1 μm, 2 μm, 3 μm, 4 μm, 5 μm, 6 μm, 7 μm, 8 μm, 9 μm, 10 μm, 11 μm 12 μm 13 μm 14 μm, 15 μm, 20 μm, or more. The length of the clothoid 12c-1 and anti-clothoid 12c-2 can be at most about 20 μm, 15 μm, 14 μm, 13 μm, 12 μm, 11 μm, 10 μm, 9 μm, 8 μm, 7 μm, 6 μm, 5 μm, 4 μm, 3 μm, 2 μm, 1 μm, or less.

Referring now to the first profile 15i of the optical waveguide 20. The first profile 15i, parametrized as i(s), includes a first line segment 11i-1, an adiabatic curve 13i, and a second line segment 11i-2 serially connected to one another. The first line segment 11i-1 has zero curvature and extends to a first inflection point (Qᵢ₁) on the first profile 15i. The second line segment 11i-2 also has zero curvature and extends from a second infection point (Qᵢ₂) on the first profile 15i. The curvature of the first profile 15i is instantaneously zero at each of its first and second inflection points.

The adiabatic curve 13i includes a clothoid 12i-1, a circular arc 14i, and an anti-clothoid 12i-2 serially connected to one another. The adiabatic curve 13i is a differentiable curve that connects the first inflection point on the first profile 15i to the second inflection point on the first profile 15i. The adiabatic curve 13i subtends the effective bending angle (θ_{eff}) in the positive azimuthal direction about the effective conformal point (Q₀) in the x-y plane. The adiabatic curve 13i has continuous curvature between the first and second inflection points of the first profile 15i, thus, the first profile 15i can be at least twice differentiable at each point.

The circular arc 14i subtends the conformal angle (θ) about the conformal point (P₀) in the x-y plane. The circular arc 14i has a first endpoint (Pᵢ₁) and a second endpoint (Pᵢ₂) on the first profile 15i and subtends the conformal angle in the positive azimuthal direction. The circular arc 14i has a radius of

$${R}_{i} = R - \frac{{w}_{m}}{2}$$

from the conformal point, an arc length of Rᵢθ between its first and second points, and a constant curvature of κᵢ(s)=Rᵢ⁻¹.

The clothoid 12i-1 connects the first inflection point on the first profile 15i to the first endpoint of the circular arc 14i. The curvature of the clothoid 12i-1 increases linearly with the path length

$${κ}_{i} ( s ) = \frac{{R}_{i}^{- 1} s}{{L}_{cth}} ,$$

from zero curvature at the first inflection point on the first profile 15i to the curvature Rᵢ⁻¹ of the circular arc 14i at its first endpoint. Consequently, the clothoid 12i-1 is an osculating curve connecting the first inflection point on the first profile 15i to the first endpoint of the circular arc 14i.

Similarly, the anti-clothoid 12i-2 connects the second endpoint of the circular arc 14i to the second inflection point on the first profile 15i. The curvature of the anti-clothoid 12i-2 decreases linearly with the path length

$${κ}_{i} ( s ) = {R}_{i}^{- 1} - \frac{{R}_{i}^{- 1} s}{{L}_{cth}} ,$$

from the curvature Rᵢ⁻¹ of the circular arc 14i at its second endpoint to zero curvature at the second inflection point on the first profile 15i. Consequently, the anti-clothoid 12i-2 is an anti-osculating curve connecting the second endpoint of the circular arc 14i to the second inflection point on the first profile 15i.

Referring last to the second profile 15o of the optical waveguide 20. The second profile 15o, parametrized as \vec{r}ₒ(s), includes a first line segment 11o-1, an adiabatic curve 13o, and a second line segment 11o-2 serially connected to one another. The first line segment 11o-1 has zero curvature and extends to a first inflection point (Qₒ₁) on the second profile 15o. The second line segment 11o-2 also has zero curvature and extends from a second infection point (Q₀₂) on the second profile 15o. The curvature of the second profile 15o is instantaneously zero at each of its first and second inflection points.

The adiabatic curve 13o includes a clothoid 12o-1, a circular arc 14o, and an anti-clothoid 12o-2 serially connected to one another. The adiabatic curve 13o is a differentiable curve that connects the first inflection point on the second profile 15o to the second inflection point on the second profile 15o. The adiabatic curve 13o subtends the effective bending angle (θ_{eff}) in the positive azimuthal direction about the effective conformal point (Q₀) in the x-y plane. The adiabatic curve 13o has continuous curvature between the first and second inflection points of the second profile 15o, thus, the second profile 15o can be at least twice differentiable at each point.

The circular arc 14o subtends the conformal angle (θ) about the conformal point (P₀) in the x-y plane. The circular arc 14o has a first endpoint (Pₒ₁) and a second endpoint (Pₒ₂) on the second profile 15o and subtends the conformal angle in the positive azimuthal direction. The circular arc 14o has a radius of

$${R}_{o} = R + \frac{{w}_{m}}{2}$$

from the conformal point, an arc length of Rₒθ between its first and second points, and a constant curvature of κₒ(s)=Rₒ⁻¹.

The clothoid 12o-1 connects the first inflection point on the second profile 15o to the first endpoint of the circular arc 14o. The curvature of the clothoid 12o-1 increases linearly with the path length

$${κ}_{o} ( s ) = \frac{{R}_{o}^{- 1} s}{{L}_{cth}} ,$$

from zero curvature at the first inflection point on the second profile 15o to the curvature Rₒ⁻¹ of the circular arc 14o at its first endpoint. Consequently, the clothoid 12o-1 is an osculating curve connecting the first inflection point on the second profile 15o to the first endpoint of the circular arc 14o.

Similarly, the anti-clothoid 12o-2 connects the second endpoint of the circular arc 14o to the second inflection point on the second profile 15o. The curvature of the anti-clothoid 12o-2 decreases linearly with the path length

$${κ}_{o} ( s ) = {R}_{o}^{- 1} - \frac{{R}_{o}^{1} s}{{L}_{cth}} ,$$

from the curvature Rₒ⁻¹ of the circular arc 14o at its second endpoint to zero curvature at the second inflection point on the second profile 15o. Consequently, the anti-clothoid 12o-2 is an anti-osculating curve connecting the second endpoint of the circular arc 14o to the second inflection point on the second profile 15o.

With the geometries of the geometric path 15c, first profile 15i, and second profile 15o defined, the overall structure of the optical waveguide 20 can now be specified.

The first inflection points Q_{c1}, Qᵢ₁, and Qₒ₁ of the geometric path 15c, first profile 15i, and second profile 15o are colinear with one another on a first effective radial line 16-1 and collectively define a first inflection point (Q₁) of the optical waveguide 20. The first effective radial line 16-1 intersects the effective conformal point (Q₀) and separates the first linear section 11-1 from the Euler section 12-1. Similarly, the second inflection points Q_{c2}, Qᵢ₂, and Qₒ₂ of the geometric path 15c, first profile 15i, and second profile 15o are colinear with one another on a second effective radial line 16-2 and collectively define a second inflection point (Q₂) of the optical waveguide 20. The second effective radial line 16-2 intersects the effective conformal point (Q₀) and separates the anti-Euler section 12-2 from the second linear section 11-2. The effective bending angle (θ_{eff}) of the adiabatic bend 10 is defined between the first 16-1 and second 16-2 effective radial lines.

The first endpoints P_{c1}, Pᵢ₁, and Pₒ₁ of the circular arcs 14c, 14i, and 14o are colinear with one another on a first radial line 18-1 and collectively define a first endpoint (P₁) of the arcuate section 14. The first radial line 18-1 intersects the conformal point (P₀) and separates the Euler section 12-1 from the arcuate section 14. Similarly, the second endpoints P_{c2}, Pᵢ₂, and Pₒ₂ of the circular arcs 14c, 14i, and 14o are colinear with one another on a second radial line 18-2 and collectively define a second endpoint (P₂) of the arcuate section 14. The second radial line 18-2 intersects the conformal point (P₀) and separates the anti-Euler section 12-2 from the arcuate section 14. The conformal angle (θ) of the arcuate section 14 is defined between the first 18-1 and second 18-2 radial lines.

The first line segments 11i-1 and 110-1 of the first 15i and second 15o profiles together define the first linear segment 11-1 of the optical waveguide 20. Within the first linear segment 11-1, the first line segments 11c-1, 11i-1, and 11o-1 are parallel to one another as the normal width of the optical waveguide 20 is constant w(s)=w₀ within the first linear segment 11-1. Similarly, the second line segments 11i-2 and 11o-2 of the first 15i and second 15o profiles together define the second linear segment 11-2 of the optical waveguide 20. Within the second linear segment 11-2, the second line segments 11c-2, 11i-2, and 11o-2 are parallel to one another as the normal width of the optical waveguide 20 is constant with path length w(s)=wₒ within the second linear segment 11-2.

The adiabatic curves 13i and 13o of the first 15i and second 15o profiles together define the adiabatic bend 10. The clothoids 12i-1 and 12o-1 of the first 15i and second 15o profiles together define the Euler section 12-1 of the optical waveguide 20. Within the Euler section 12-1, the clothoids 12c-1, 12i-1, and 12o-1 are non-parallel to one another as the normal width of the optical waveguide 20 increases linearly with path length

$$w ( s ) = {w}_{0} + \frac{( {w}_{m} - {w}_{0} ) s}{{L}_{cth}}$$

within the Euler section 12-1. Similarly, the anti-clothoids 12i-2 and 12o-2 of the first 15i and second 15o profiles together define the anti-Euler section 12-2 of the optical waveguide 20. Within the anti-Euler section 12-2, the anti-clothoids 12c-2, 12i-2, and 12o-2 are non-parallel to one another as the normal width of the optical waveguide 20 decreases linearly with path length

$$w ( s ) = {w}_{m} + \frac{( {w}_{0} - {w}_{m} ) s}{{L}_{cth}}$$

in the anti-Euler section 12-2. Finally, the circular arcs 14i and 14o of the first 15i and second 15o profiles together define the arcuate section 14 of the optical waveguide 20. Within the arcuate section 14, the circular arcs 14c, 14i, and 14o are parallel to one another as the normal width of the optical waveguide 20 is constant with path length w(s)=wₘ in the arcuate section 14.

Note that with a bend parameter of 0<p<1, each of the arcuate section 14, Euler section 12-1, and anti-Euler section 12-2 has non-zero length. For the first extreme p=1, the arcuate section 14 disappears such that the conformal angle is zero θ=0. In this case, the adiabatic bend 10 reduces to the Euler 12-1 and anti-Euler 12-2 sections connected to each other. Such implementations may also be utilized but typically the arcuate section 14 improves performance of the adiabatic bend 10. For the second extreme p=0, the Euler 12-1 and anti-Euler 12-2 sections disappear such that the conformal angle equals the effective bending angle θ=θ_{eff}. In this case, the adiabatic bend 10 reduces to the arcuate section 14. However, as the arcuate section 14 has constant curvature and the first 11-1 and second 11c-2 linear sections have zero curvature, the first (Q₁) and second inflection (Q₂) points of the optical waveguide 20 would now be discontinuous, corresponding to a discontinuous second derivative. Such discontinuities are known to result in high optical losses, e.g., radiation and bending losses, as well as the excitation of higher order modes, which are remedied by the Euler 12-1 and anti-Euler 12-2 sections of the adiabatic bend 10.

The adiabatic bend 10 can be used for each bend of an optical waveguide to optimize its optical properties for an integrated photonic device 5. As described in more detail below, combinations of the adiabatic bend 10 with both positive and negative curvature can be utilized to construct even more complex geometries for designing novel optical components.

Note, the adiabatic bend 10 described above will be referred to hereinafter as a positive adiabatic bend 10 as it has positive orientated curvature k(s)=+κ(s) and subtends the effective bending angle in the positive azimuthal direction. On the other hand, a negative adiabatic bend 10′ has negative orientated curvature k(s)=−κ(s) and subtends the effective bending angle in the negative azimuthal direction. In this case, the arcuate section 12 becomes an arcuate section 12′ that has a constant negative curvature and subtends the conformal angle in the negative azimuthal direction, the Euler section 12-1 becomes an anti-Euler section 12′-2 with a curvature that decreases linearly from zero curvature to the negative curvature of the arcuate section 12′, and the anti-Euler section 12-2 becomes an Euler section 12′-1 that has a curvature that increases linearly from the negative curvature of the arcuate section 12′ to zero curvature. In other words, the negative adiabatic bend 10′ is the mirror image of the positive adiabatic bend 10. Thus, the above discussion for the positive adiabatic bend 10 holds identically for the negative adiabatic bend 10′ by inverting the curvature K(s)→−κ(s) of the positive adiabatic bend 10, which is equivalent to reflecting the positive adiabatic bend 10 about the y-axis.

Before proceeding, it useful to compute a few geometric and optical properties of the adiabatic bend 10 that are relevant for an integrated photonic device 5. The total path length of the optical waveguide 20 within the adiabatic bend 10 is given as:

$$L = \int ds = R θ + 2 {L}_{cth} . \qquad ( 6 )$$

where the first term is the arc length of the arcuate section 14 and the second term is sum total length of the Euler 12-1 and anti-Euler 12-2 sections.

Similarly, the total volume of the optical waveguide 20 within the adiabatic bend 10 is given as:

$$V = {h}_{0} \int w ( s ) ds = {h}_{0} {w}_{m} R θ + {h}_{0} ( {w}_{0} + {w}_{m} ) {L}_{cth} . \qquad ( 7 )$$

where the first term is the volume of the arcuate section 14 and the second term is the sum total volume of the Euler 12-1 and anti-Euler 12-2 sections.

Taking into account the effective refractive index (n_{eff}) of the optical waveguide 20, the optical path length (OPL) of the optical waveguide 20 can be defined as:

$$OPL = \int {n}_{eff} [ w ( s ) ] ds . \qquad ( 8 )$$

Since, the normal width of the optical waveguide 20 changes with path length within the adiabatic bend 10, the effective refractive index also changes. In practice, the relationship between the effective refractive index and the normal width is often nonlinear. However, for many practical implementations of the optical waveguide 20, e.g., silicon photonics implementations, the effective refractive index can be approximated empirically or using numerical methods. One such approximation is:

$${n}_{eff} [ w ( s ) ] = {n}_{0} - Δ n exp [ - α w ( s ) ] , \qquad ( 9 )$$

where Δn=nₒ−n_{clad} is the difference between the refractive index of the core layer 114 and the refractive index of the cladding layer 116, and α is a scaling factor that determines how quickly the effective refractive index changes with the normal width of the optical waveguide 20. In some implementations, the scaling factor can be in a range from about 0.1 μm⁻¹ to 1 μm⁻¹. For example, the scaling factor can be at least about 0.1 μm⁻¹, 0.2 μm⁻¹, 0.3 μm⁻¹, 0.4 μm¹, 0.5 μm⁻¹, 0.6 μm⁻¹, 0.7 μm⁻¹, 0.8 μm⁻¹, 0.9 μm⁻¹, 1 μm¹, or more. The scaling factor can be at most about 1 μm⁻¹, 0.9 μm⁻¹, 0.8 μm⁻¹, 0.7 μm⁻¹, 0.6 μm⁻¹, 0.5 μm⁻¹, 0.4 μm⁻¹, 0.3 μm⁻¹, 0.2 μm⁻¹, 0.1 μm⁻¹, or less. In this case, the OPL of the optical waveguide 20 over the adiabatic bend 10 is given as:

$$OPL = [ {n}_{0} - Δn exp ( - α {w}_{m} ) ] R θ + 2 [ {n}_{0} - Δ n \frac{exp ( - α {w}_{m} ) - exp ( - α {w}_{0} )}{α ( {w}_{0} - {w}_{m} )} ] {L}_{cth} , \qquad ( 10 )$$

where the first term is the OPL of the arcuate section 14 and the second term is the sum total OPL of the Euler 12-1 and anti-Euler 12-2 sections.

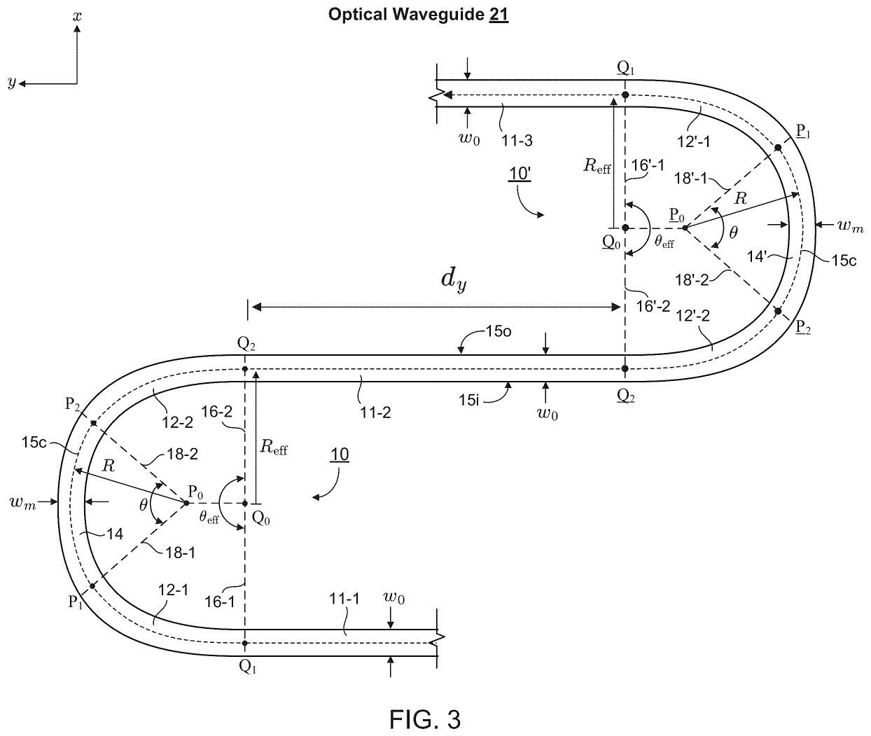

FIG. 3 is a top view of an example of an optical waveguide 21 with a serpentine geometric path 15c. The optical waveguide 21 is an example of an optical waveguide that can be used for a MZI 500 to significantly increase the OPL of light in a highly compact form factor, with tight bending angles and radii, and with low optical losses.

As shown in FIG. 3, the optical waveguide 21 includes a first linear section 11-1, a positive adiabatic bend 10, a second linear section 12-2, a negative adiabatic bend 10′, and a third linear section 11-3 serially connected to one another.

The positive adiabatic bend 10 connects a first inflection point (Q₁) to a second infection (Q₂) of the optical waveguide 21. The positive adiabatic bend 10 subtends an effective bending angle (θ_{eff}) of 180 degrees in the positive azimuthal direction about an effective conformal point (Q₀), forming a tight, clockwise hairpin turn. The positive adiabatic bend 10 includes a Euler section 12-1, an arcuate section 14, and an anti-Euler section 12-2 serially connected to one another. The arcuate section 14 subtends a conformal angle (θ) from a first endpoint (P₁) to a second endpoint (P₂) about a conformal point (P₀). The Euler section 12-1 connects the first inflection point to the first endpoint of the arcuate section 14, and the anti-Euler section 12-2 connects the second endpoint of the arcuate section 14 to the second inflection point.

The negative adiabatic bend 10′ exactly mirrors the positive adiabatic bend 10 about the y-axis. The negative adiabatic bend 10′ connects a first inflection point (Q₂) to a second infection (Q₁) of the optical waveguide 21. The negative adiabatic bend 10′ subtends the effective bending angle (θ_{eff}) of 180 degrees in the negative azimuthal direction about an effective conformal point (Q₀), forming a tight, counterclockwise hairpin turn. The negative adiabatic bend 10′ includes an anti-Euler section 12′-2, an arcuate section 14′, and a Euler section 12′-1 serially connected to one another. The arcuate section 14′ subtends the conformal angle (θ) from a first endpoint (P₂) to a second endpoint (P₁) about a conformal point (P₀). The anti-Euler section 12′-2 connects the first inflection point to the first endpoint of the arcuate section 14′, and the Euler section 12′-1 connects the second endpoint of the arcuate section 14′ to the second inflection point.

The first 11-1, second 11-2, and third 11-3 linear sections are parallel to one another. The first linear section 11-1 is connected to the first inflection point of the positive adiabatic bend 10, the second linear section 11-2 connects the second inflection point of the positive adiabatic bend 10 to the first inflection point of the negative adiabatic bend 10′, and the third linear section 11-3 is connected to the second inflection point of the negative adiabatic bend 10′.

Multiple ones of the optical waveguide 21 can be serially connected to one another to create an optical waveguide that follows a serpentine geometric path 15c with many clockwise and counterclockwise hairpin turns, e.g., 2, 3, 4, 5, 10, 15, 20, 25, 50, 75, 100, 200 or more hairpin turns. The y-axis distance (d_{y}) between the effective conformal point (Q₀) of the positive adiabatic bend 10 and the effective conformal point (Q₀) of the negative adiabatic bend 10′ defines the traversed distance of the optical waveguide 21, corresponding to the incremental increase in OPL for each hairpin turn. In some implementations, the traversed distance can be in a range from about 100 μm to 1,000 μm. For example, the traversed distance can be at least about 100 μm, 200 μm, 300 μm, 400 μm, 500 μm, 600 μm, 700 μm, 800 μm, 900 μm, 1,000 μm, or more. The traversed distance can be at most about 1,000 μm, 900 μm, 800 μm, 700 μm, 600 μm, 500 μm, 400 μm, 300 μm, 200 μm, 100 μm, or less.

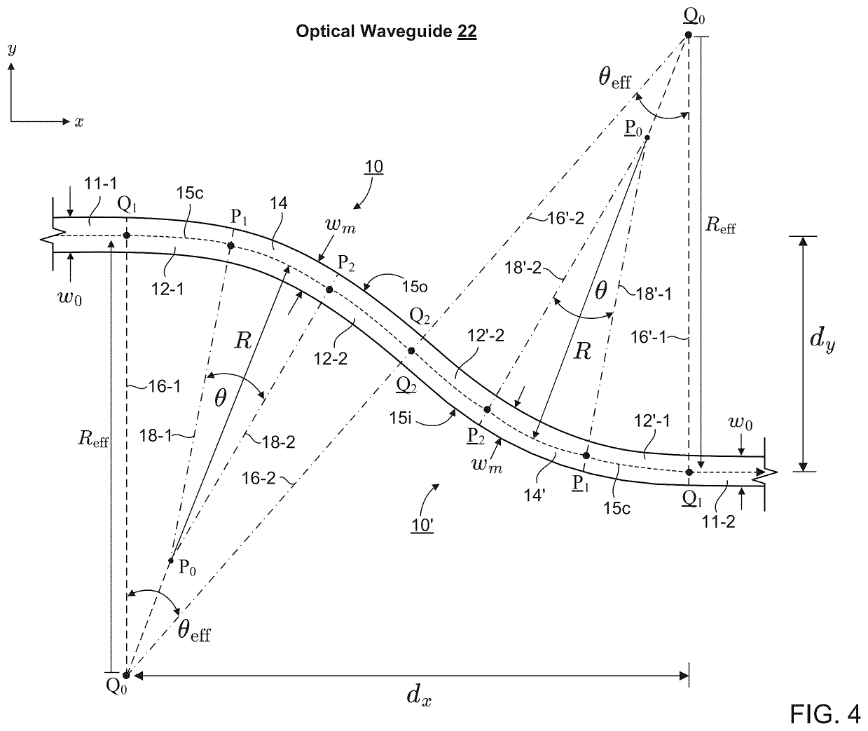

FIG. 4 is a top view of an example of an optical waveguide 22 with a diverted geometric path 15c. The optical waveguide 22 is an example of an optical waveguide that can be used for a polarization splitter rotator 200, optical tap 300, or optical WDM filter 400 to divert the optical waveguide at tight bending angles and radii with low optical losses.

As shown in FIG. 4, the optical waveguide 22 includes a first linear section 11-1, a positive adiabatic bend 10, a negative adiabatic bend 10′, and a second linear section 11-2 serially connected to one another. The optical waveguide 22 is configured similarly to the optical waveguide 21 of FIG. 3 except the positive 10 and negative 10′ adiabatic bends are directly connected to each other and subtend an effective bending angle of less than 90 degrees, e.g., 45 degrees.

The x-axis distance (dₓ) between the effective conformal point (Q₀) of the positive adiabatic bend 10 and the effective conformal point (Q₀) of the negative adiabatic bend 10′ defines the traversed distance of the optical waveguide 22. The traversed distance is on the order of the effective bending radius (R_{eff}). In some implementations, the traversed distance can be in a range from about 1 μm to 10 μm. For example, the traversed distance can be at least about 1 μm, 2 μm, 3 μm, 4 μm, 5 μm, 6 μm, 7 μm, 8 μm, 9 μm, 10 μm, or more. The traversed distance can be at most about 10 μm, 9 μm, 8 μm, 7 μm, 6 μm, 5 μm, 4 μm, 3 μm, 2 μm, 1 μm, or less.

Similarly, the y-axis distance (d_{y}) between the first inflection point (Q₁) of the positive adiabatic bend 10 and the second inflection point (Q₂) of the negative adiabatic bend 10′ defines the diverted distance of the optical waveguide 22. The diverted distance is on the order of the effective bending radius (R_{eff}). In some implementations, the diverted distance can be in a range from about 1 μm to 10 μm. For example, the diverted distance can be at least about 1 μm, 2 μm, 3 μm, 4 μm, 5 μm, 6 μm, 7 μm, 8 μm, 9 μm, 10 μm, or more. The distance (d_{y}) can be at most about 10 μm, 9 μm, 8 μm, 7 μm, 6 μm, 5 μm, 4 μm, 3 μm, 2 μm, 1 μm, or less.

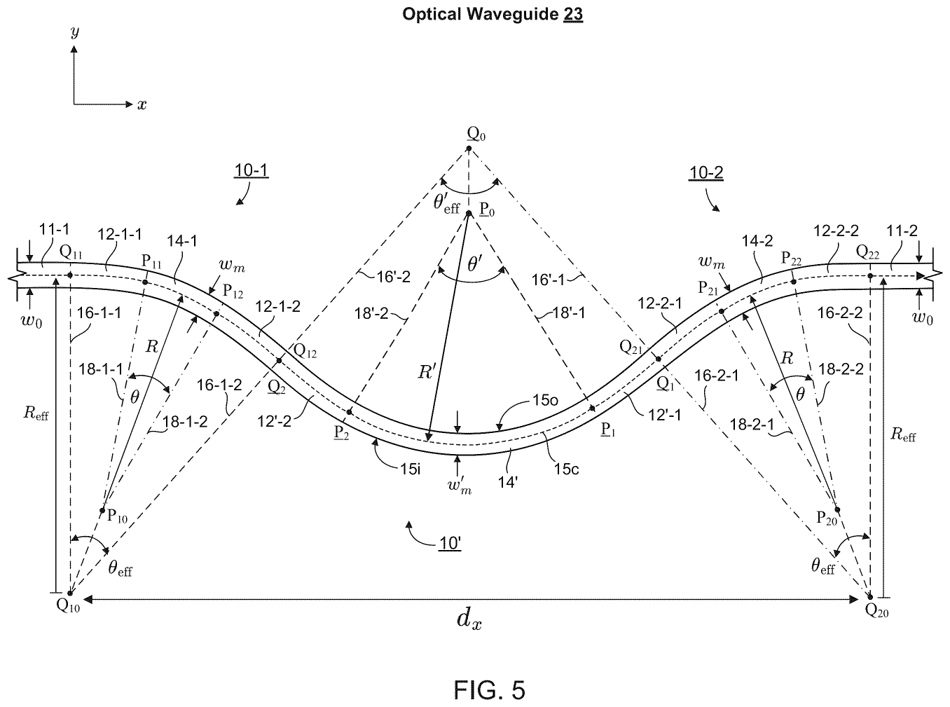

FIG. 5 is a top view of an example of an optical waveguide 23 with a conformal geometric path 15c. The optical waveguide 23 is an example of an optical waveguide that can be used as a bus waveguide for efficiently coupling to a circular resonator 100 (or another bus waveguide) with low optical losses.

As shown in FIG. 5, the optical waveguide 23 includes a first linear section 11-1, a first positive adiabatic bend 10-1, a negative adiabatic bend 10′, a second positive adiabatic bend 20-2, and a second linear section 11-2 serially connected to one another. The optical waveguide 23 is configured similarly to the optical waveguide 22 of FIG. 4 except the optical waveguide 23 includes the second positive adiabatic bend 20-2 and the negative adiabatic bend 10′ has differing geometric parameters.

Particularly, the positive adiabatic bends 10-1 and 10-2 are copies of each other, having the same effective bending angle (θ_{eff}), conformal angle (θ), arcuate radius (R), and axillary width (wₘ). On the other hand, the negative adiabatic bend 10′ has a different effective bending angle (θ′_{eff}), effective bending radius (R′_{eff}), conformal angle (θ′), and auxiliary width (w′ₘ).

The x-axis distance (dₓ) between the effective conformal point (Q₁₀) of the first positive adiabatic bend 10-1 and the effective conformal point (Q₂₀) of the second positive adiabatic bend 10-2 defines the traversed distance of the optical waveguide 23. In some implementations, the traversed distance can be in a range from about 10 μm to 100 μm. For example, the traversed distance can be at least about 10 μm, 20 μm, 30 μm, 40 μm, 50 μm, 60 μm, 70 μm, 80 μm, 90 μm, 100 μm, or more. The traversed distance can be at most about 100 μm, 90 μm, 80 μm, 70 μm, 60 μm, 50 μm, 40 μm, 30 μm, 20 μm, 10 μm, or less.

Here, the effective bending angle of the negative adiabatic bend 10′ is equal to the sum of the effective bending angles of the positive adiabatic bends 10-1 and 10-2, i.e., θ′_{eff}=2θ_{eff}, such that the first 11-1 and 12-2 second linear sections are colinear with each other. The optical waveguide 23 can provide a near optimal means of coupling optical components with circular geometries. Particularly, the conformal point (P₀) of the negative adiabatic bend 10′ provides a common conformal point about which to evanescently couple with other circularly shaped optical components, over a large coupling (or interaction) length.

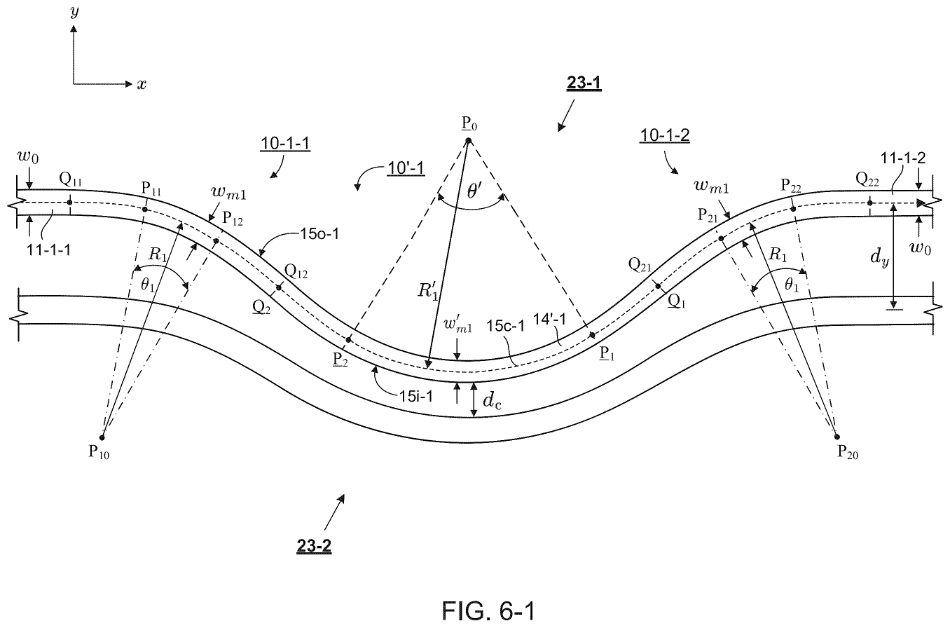

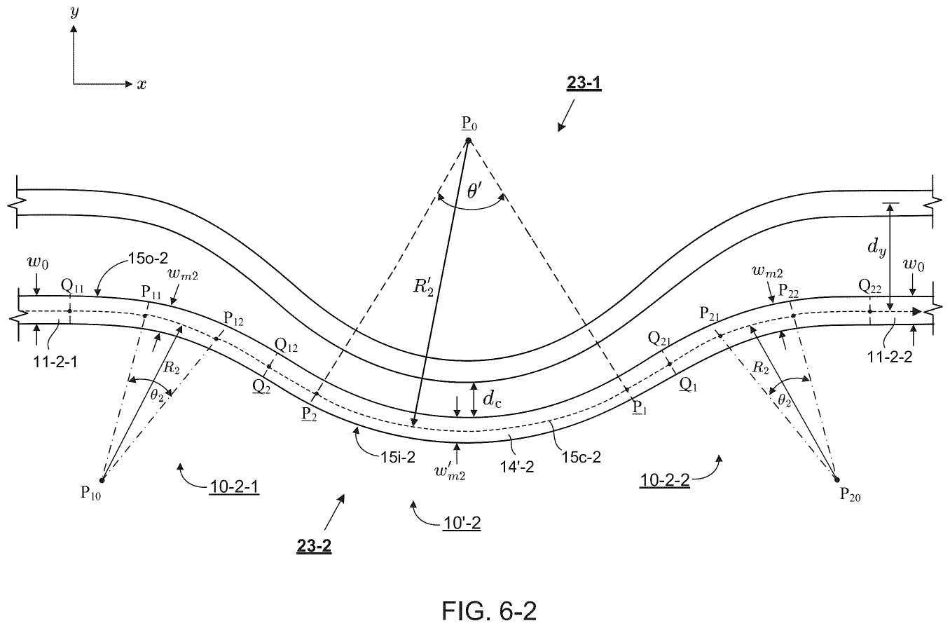

FIGS. 6-1 and 6-2 are top views of an example of two evanescently coupled optical waveguides 23-1 and 23-2 each of the type shown in FIG. 5 with a conformal geometric path 15c-1 and 15c-2. Here, the optical waveguides 23-1 and 23-2 are conformally coupled about a common conformal point.

The first optical waveguide 23-1 includes a first linear section 11-1-1, a first positive adiabatic bend 10-1-1, a negative adiabatic bend 10′-1, a second positive adiabatic bend 10-1-2, and a second linear section 11-1-2 serially connected to one another. The positive adiabatic bends 10-1-1 and 10-1-2 have conformal angles of θ₁, radiuses of R₁, and auxiliary widths of wₘ₁. The negative adiabatic bend 10′-1 has a conformal angle of θ′, an arcuate radius of R′₁, and an auxiliary width of w′₁.

The second optical waveguide 23-2 includes a first linear section 11-2-1, a first positive adiabatic bend 10-2-1, a negative adiabatic bend 10′-2, a second positive adiabatic bend 10-2-2, and a second linear section 11-2-2 serially connected to one another. The positive adiabatic bends 10-2-1 and 10-2-2 have conformal angles of θ₂, arcuate radiuses of R₂, and auxiliary widths of wₘ₂. The negative adiabatic bend 10′-2 has the same conformal angle of θ′ as the negative adiabatic bend 10′-1, but an arcuate radius of R and an auxiliary width of w′ₘ₂.

As shown in FIGS. 6-1 and 6-2, the negative adiabatic bends 10′-1 and 10′-2 share a common conformal point (P₀), such that their respective arcuate sections 14′-1 and 14′-2 are parallel and adjacent to each other. The arcuate sections 14′-1 and 14′-2 can be strongly evanescently coupled to each other over a coupling length (L_{c}) of about L_{c}=(R′₁+w′ₘ₁/2+d_{c}/2)θ′. Within the conformal angle (θ′) of the negative adiabatic bends 10′-1 and 10′-2, a distance (d_{c}) between the first profile 15i-1 of the first optical waveguide 23-1 and the second profile 15o-2 of the second optical waveguide 23-1 specifies the coupling spacing.

The coupling spacing (d_{c}) between the arcuate sections 14′-1 and 14′-2 influences the strength of the evanescent coupling and is given as d_{c}=R′₂−w′ₘ₂/2−R′₁+w′ₘ₁/2. The arcuate radiuses R′₁ and R′₂ of the negative adiabatic bends 10′-1 and 10′-2 can be targeted to select a particular value for the coupling spacing, independent of the other geometric parameters of the optical waveguides 23-1 and 23-2. Thus, the coupling spacing (d_{c}) and differing auxiliary widths w′ₘ₁ and w′ₘ₂ of the negative adiabatic bends 10′-1 and 10′-2 can be individually tuned to provide near optimal phase matching, reduced optical losses, and coupling efficiency between the optical waveguides 23-1 and 23-2. For example, the optical waveguides 23-1 and 23-2 can be designed with broadband splitting ratio, reduced insertion and radiation losses, low multi-mode interference (MMI), and a highly compact geometry.

### IV. Examples of Optical Add-Drop Filters Utilizing Adiabatic Bends

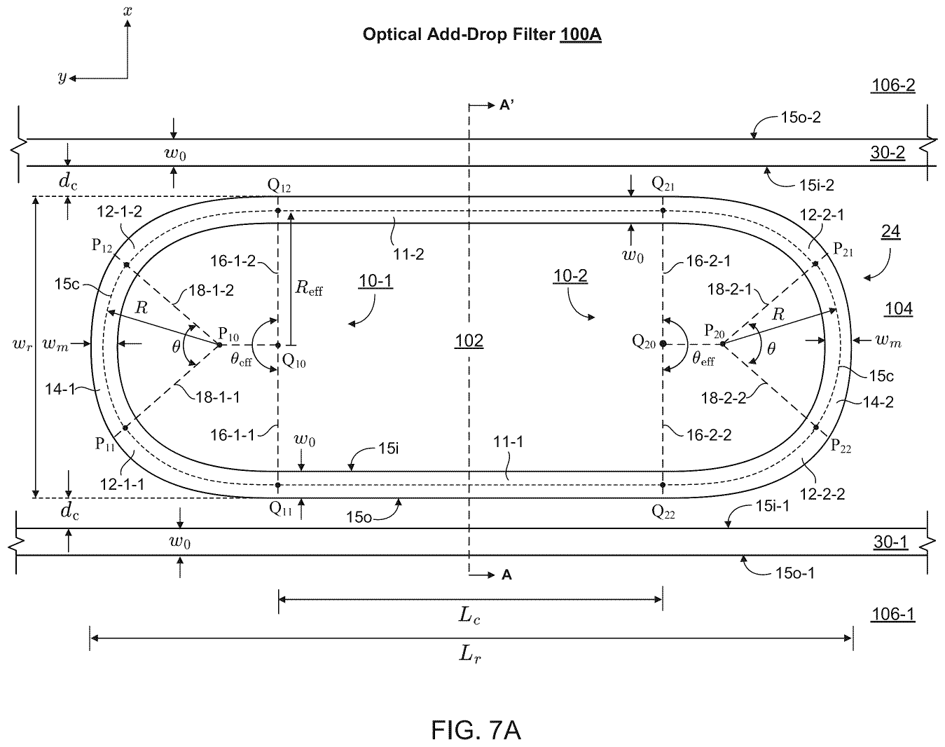

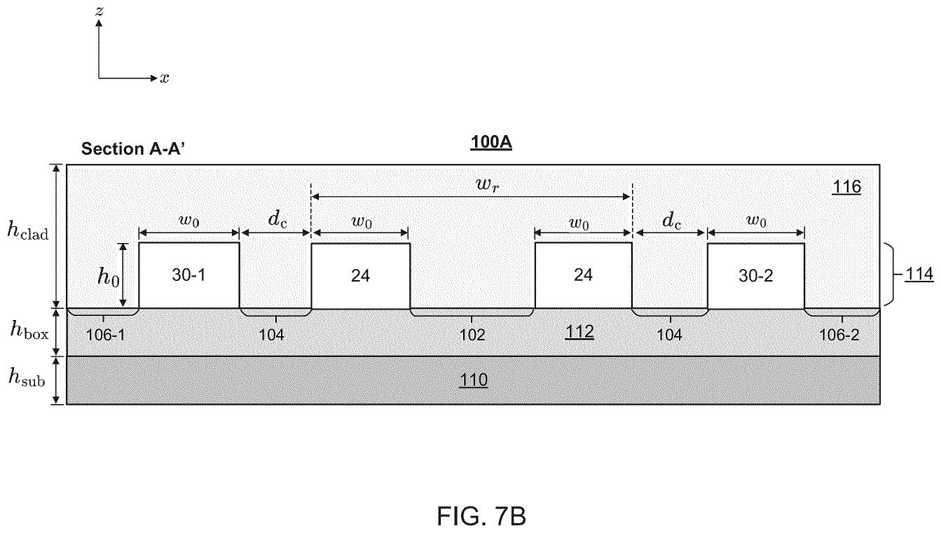

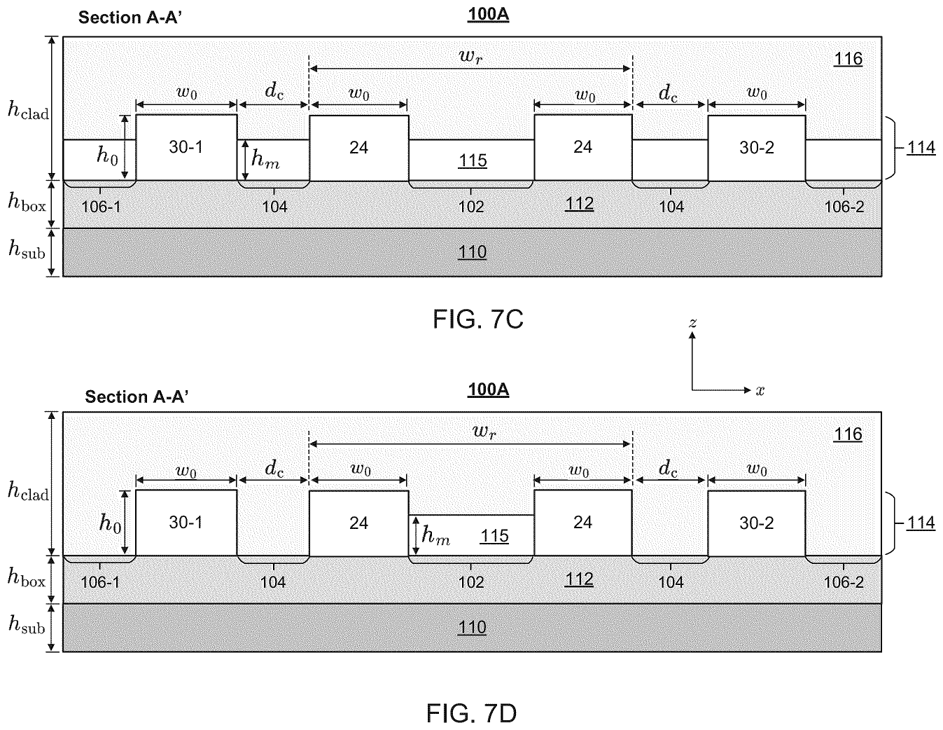

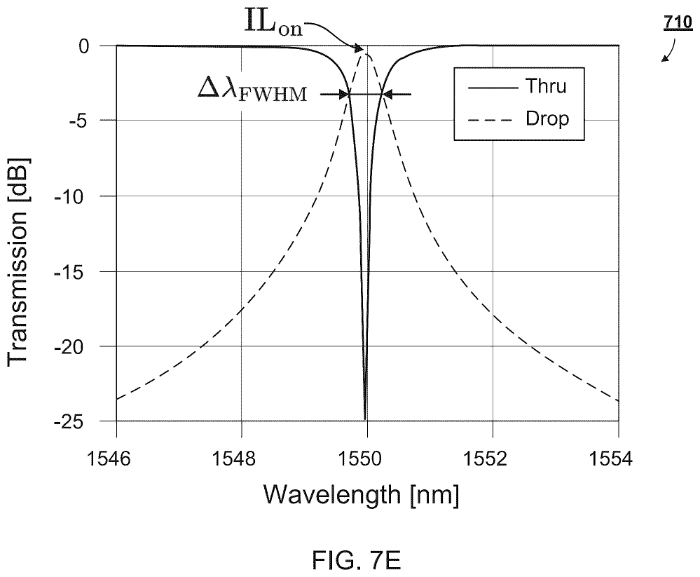

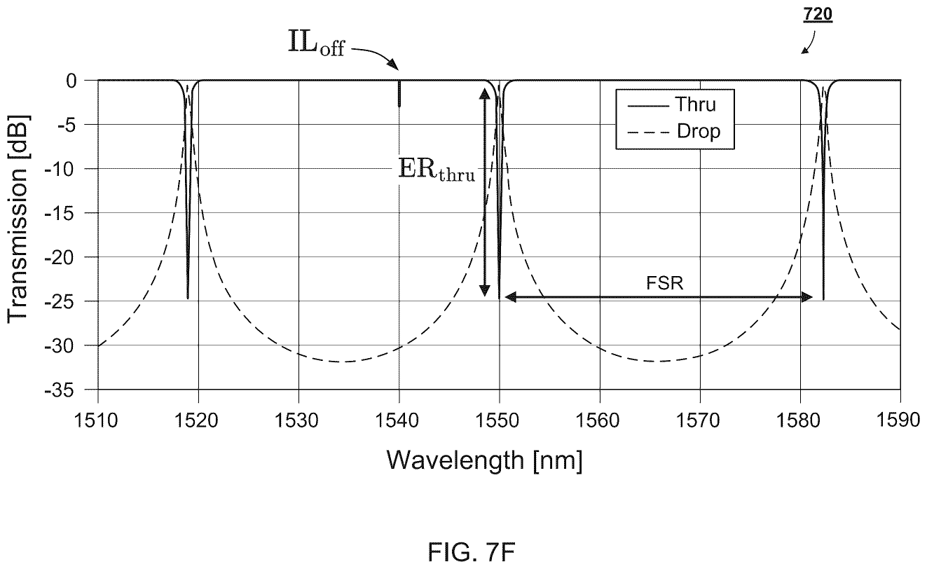

FIG. 7A is a top view of an example of an optical add-drop filter 100A. The optical add-drop filter 100A is a racetrack-resonator add-drop filter 100A that includes a racetrack resonator 24, a first bus optical waveguide 30-1, and a second bus optical waveguide 30-2.

The racetrack resonator 24 is a looped optical waveguide that includes a first linear section 11-1, a first adiabatic bend 10-1, a second linear section 12-2, and a second adiabatic bend 10-2 serially connected to one another.

The first adiabatic 10-1 is a positive adiabatic bend that connects a respective first inflection point (Q₁₁) to a respective second infection (Q₁₂) of the racetrack resonator 24. The first adiabatic 10-1 subtends an effective bending angle (θ_{eff}) of 180 degrees in the positive azimuthal direction about a first effective conformal point (Q₁₀). The second adiabatic 10-1 is also a positive adiabatic bend that connects a respective first inflection point (Q₂₁) to a respective second infection (Q₂₂) of the racetrack resonator 24. The second adiabatic 10-2 subtends the effective bending angle (θ_{eff}) of 180 degrees in the positive azimuthal about a second effective conformal point (Q₂₀).

The first 11-1 and second 11-2 linear sections are parallel to each other. The first linear section 11-1 connects the second inflection point of the second adiabatic bend 11-2 to the first inflection point of the first adiabatic bend 10-1. The second linear section 11-2 connects the second inflection point of the first adiabatic bend 10-1 to the first inflection point of the second adiabatic bend 10-2. The first 11-1 and second 11-2 linear sections each have a length of Le between the inflection points which is the approximate coupling length of the racetrack resonator 24. In some implementations, the first 11-1 and second 11-2 linear sections can each have a length in a range from about 50 μm to 500 μm. For example, the first 11-1 and second 11-2 linear sections can each have a length of at least about 50 μm, 100 μm, 150 μm, 200 μm, 250 μm, 300 μm, 350 μm, 400 μm, 450 μm, 500 μm, or more. The first 11-1 and second 11-2 linear sections can each have a length of at most about 500 μm, 450 μm, 400 μm, 350 μm, 300 μm, 250 μm, 200 μm, 150 μm, 100 μm, 50 μm, or less.

The width (wᵣ) of the racetrack resonator 24 is determined by the effective bending radius of the adiabatic bends 10-1 and 10-2 and the operation width as wᵣ=2R_{eff}+w₀. The racetrack resonator 24 can have a total length (Lᵣ) in a range from about 100 μm to 1,000 μm. For example, the racetrack resonator 24 can have a length of at least about 100 μm, 200 μm, 300 μm, 400 μm, 500 μm, 600 μm, 700 μm, 800 μm, 900 μm, 1,000 μm, or more. The racetrack resonator 24 can have a length of at most about 1,000 μm, 900 μm, 800 μm, 700 μm, 600 μm, 500 μm, 400 μm, 300 μm, 200 μm, 100 μm, or less.

The geometric path 15c of the racetrack resonator 24 forms a closed loop which sets a resonance condition for constructive interference, corresponding to a looped OPL of:

$$q {λ}_{q} = 2 [ {n}_{0} - Δ n exp ( - α {w}_{0} ) ] {L}_{c} + 2 [ {n}_{0} - Δ n exp ( - α {w}_{m} ) ] R θ + 4 [ {n}_{0} - Δ n \frac{exp ( - α {w}_{m} ) - exp ( - α {w}_{0} )}{α ( {w}_{0} - {w}_{m} )} ] {L}_{cth} , \qquad ( 11 )$$

where the first term is the sum total OPL of the linear sections 11-1 and 11-2, and the second and third terms are sum total OPL of the adiabatic bends 10-1 and 10-2. Here, λ_{q} is the resonant wavelength and q is the mode number of the racetrack resonator 24. Equation (11) implies that in order for light to interfere constructively inside the racetrack resonator 24, the OPL must be an integer multiple of the wavelength of the light, see FIGS. 7E and 7F for example. Among the other optical properties described above, the parameters of the adiabatic bends 10-1 and 10-2, such as the auxiliary width (w_m), the clothoid length (L_{cth}), conformal angle (θ), and arcuate radius (R) can be individually tuned to alter the modal spectrum of the racetrack resonator 24.

The first 30-1 and second 30-2 bus waveguides are each evanescently coupled to the racetrack resonator 24 and have widths equal to the operational width (w₀). The first bus waveguide 30-1 is parallel, adjacent, and evanescently coupled to the first linear section 11-1 of the racetrack resonator 24. The second bus waveguide 30-1 is parallel, adjacent, and evanescently coupled to the second linear section 11-2 of the racetrack resonator 24. The distance between the first profile 15i-1 of the first bus waveguide 30-1 and the second profile 15o of the racetrack resonator 24 specifies the coupling spacing between the two. Similarly, the distance between the first profile 15i-2 of the second bus waveguide 30-2 and the second profile 15o of the racetrack resonator 24 specifies the coupling spacing between the two. The coupling spacing (d_{c}) between the first 30-1 and second 30-2 bus waveguides and the first 11-1 and second 11-2 linear sections influences the strength of the evanescent coupling. In some implementations, the coupling spacing can be in range from about 100 nm to 1 μm. For example, the spacing can be at least about 100 nm, 200 nm, 300 nm, 400 nm, 500 nm, 600 nm, 700 nm, 800 nm, 900 nm, 1 μm, or more. The spacing can be at most about 1 μm, 900 nm, 800 nm, 700 nm, 600 nm, 500 nm, 400 nm, 300 nm, 200 nm, 100 nm, or less.

As shown in FIG. 7A, the first profile 15i of the racetrack resonator 24 encloses an inner area 102 of the optical add-drop filter 100A, the second profile 15o of the racetrack resonator 24 and the first profiles 15i-1 and 15i-2 of the bus waveguides 30-1 and 30-2 bound a middle area 104 of the optical add-drop filter 100A, and the second profiles 15o-1 and 15o-2 of the bus waveguides 30-1 and 30-2 bound respective outer areas 106-1 and 106-2 of the optical add-drop filter 100A. FIGS. 7B-7D are cross-sectional views (Section A-A′) of the racetrack-resonator add-drop filter 100A shown in FIG. 7A with different layer stack configurations. As shown in FIGS. 7B-7D, each of the inner area 102, middle area 104, first outer area 106-1, and second outer area 106-2 can be respectively filled with the ridge layer 115 to provide electrical contacts for the racetrack-resonator add-drop filter 100A. In FIG. 7B, the ridge layer 115 is omitted. In FIG. 7C, the ridge layer 115 fills each of the inner area 102, the middle area 104, the first outer area 106-1, and the second outer area 106-2. In FIG. 7D, the ridge layer 115 only fills the inner area 102.

FIGS. 7E and 7F include plots 710 and 720 showing design parameters of the racetrack-resonator add-drop filter 100A, as well as other resonant filters 100 described herein. Designs for optical add-drop resonant filters 100 generally balance performance parameters, such as the free spectral range (FSR), the insertion loss (IL) both on- and off-resonance, the filter bandwidth, e.g., full width half max (FWHM), spectral shape, susceptibility to intra- and inter-substrate thickness variations, and tuning efficiency.

The solid line in plots 710 and 720 corresponds to the “thru” light of the racetrack-resonator add-drop filter 100A, and the dotted line corresponds to the “dropped” light of the racetrack-resonator add-drop filter 100A. The thru light corresponds to light that enters at an input port of the first bus waveguide 30-1 and passes through to an output port. The dropped light corresponds to light that enters at an input port of the second bus waveguide 30-2 and is dropped by the racetrack resonator 24.

In plot 710, the transmission of the thru light is generally flat except for a sharply descending drop centered at a resonant frequency, e.g., about 1550 nm. The FWHM of the drop is Δλ_{FWHM}. The transmission of the dropped light is a wide peak starting at a negative value and centered at the resonant frequency. Plot 710 illustrates how most of the thru light is transmitted through the racetrack resonator 24 except near the resonant frequency, and most of the “dropped” light is at least partially not transmitted except near the resonant frequency. The on-resonant insertion loss (ILₒₙ), e.g., the insertion loss at the resonant frequency, is the difference between the peak of the dropped light and zero, which represents how much light is not dropped by the racetrack resonator 24.

In plot 720, the thru light and dropped light is displayed over a wider wavelength range and transmission range. The distance between neighboring pits of the thru light (or the distance between neighboring peaks of the dropped light) is the free spectral range (FSR) of the racetrack-resonator add-drop filter 100A. The range in transmission of the thru light is the extinction ratio (ERₜₕᵣᵤ). In addition to there being insertion loss on resonance, there is also off-resonance insertion loss (IL_{off}), which can occur when resonators include tight bends and sharp transitions. Such insertion loss is minimized for the racetrack resonator 24 with the implementation of the adiabatic bends 10-1 and 10-2.

In general, optimizing for one design feature can come at the expense of another design feature, e.g., there are trade-offs between design parameters. For example, increasing the FSR can increase the total number of wavelength channels for a fixed spacing, which can also result in a smaller cross-section of the racetrack resonator 24. However, smaller racetrack resonators can suffer worse insertion loss and reduce the available coupling length (L_{c}) and thus the FWHM per channel bandwidth. Additionally, multimode resonators typically have better insertion loss compared to single mode resonators and are more robust given the same fabrication techniques.

However, the presence of higher order modes can corrupt the FSR. In some implementations, to reduce the corruption of the FSR, conformal mode selective couplers composed of sharp and narrow S-bends can be used, but the conformal load selective couplers can worsen the off-resonance insertion loss.

Using a conformal coupler with an adiabatic bend 10 can avoid some of the above-mentioned drawbacks. For example, optimizing for a Figure of Merit (FOM), e.g., FSR, ILₒₙ/IL_{off}, and FWHM, for a particular application can result in a robust and efficient device for multiplexing with low insertion loss. The device can be a wave-division multiplexing (WDM) receiver with a wide FSR and high bandwidth per channel, with low insertion loss per channel, e.g., 0.2 dB or less. Determining the FOM can include finding a limit for the number of wavelength channels (N_{λ}) allowed in the WDM system for a cascaded add-drop resonant filter operating over a single resonator FSR. In some implementations, the number of wavelength channels is determined by:

$${N}_{λ} = floor [ min ( \frac{FSR}{Δ {λ}_{channel}} , \frac{{IL}_{limit}}{{IL}_{off}} + 1 ) ] , \qquad ( 12 )$$

where Δλ_{channel} is the channel spacing and the wavelength or frequency domain (depending on how FSR is defined), and ILₗᵢₘᵢₜ is defined as the maximum allowable difference in insertion loss between the first channel and the last channel of the cascaded add-drop resonant filter. In general, determining the FOM includes maximizing FSR and minimizing IL_{off}. An aggregate bandwidth of the given add-drop resonant filter is determined by the number of wavelength channels (N_{λ}) multiplied by the bandwidth per channel (f_{λ}). Add-drop resonant filters are configured such that the resonator bandwidth, e.g., the FWHM, permits the requisite channel bandwidth around the carrier frequency.

In some implementations, increasing the coupling strength between the between the first 30-1 and second 30-2 bus waveguides and the racetrack resonator 24 can increase the FOM by increasing the channel bandwidth around the carrier frequency. For example, reducing the coupling spacing (d_{c}) between the first 30-1 and second 30-2 bus waveguides and the racetrack resonator 24 and increasing the coupling length (L_{c}), e.g., the region where either of the first 30-1 and second bus 30-2 waveguides are sufficiently close to the racetrack resonator 24, can increase the coupling strength between the first 30-1 and second 30-2 bus waveguides and the racetrack resonator 24. The spacing (c) between the first 30-1 and second 30-2 bus waveguides and the racetrack resonator 24 is limited by foundry process specifications. Increasingly the coupling length introduces a design trade-off between the resonator path length and thus FSR and the bandwidth per channel f_{λ}. To maximize the aggregate bandwidth, as much of the resonator path length should be a part of the coupling regions as possible, which results in the racetrack resonator 24 with the adiabatic bend 10 geometry.

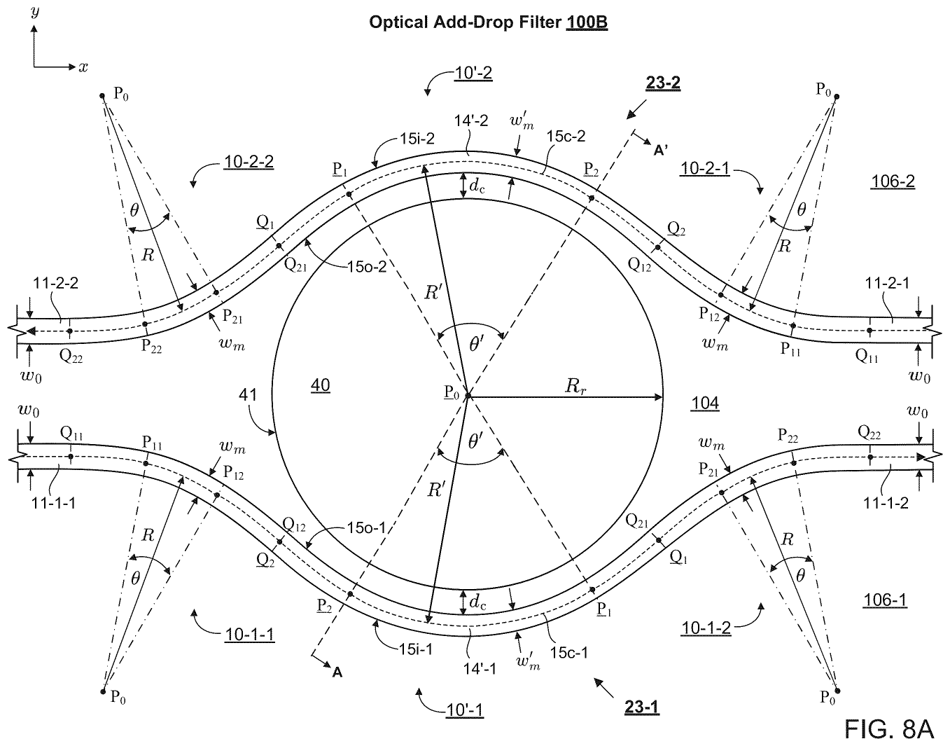

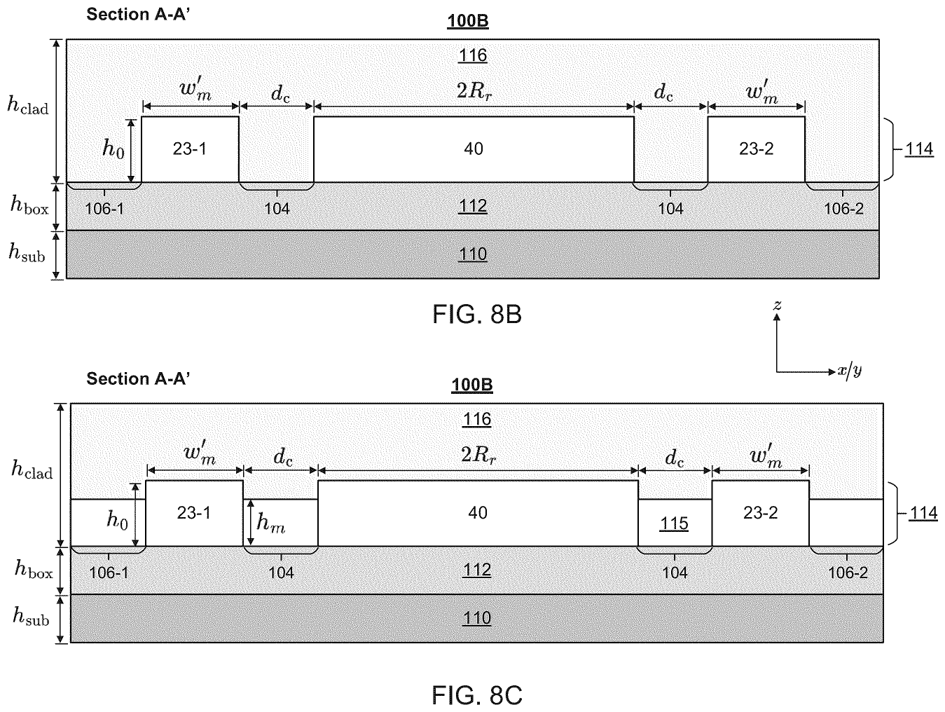

FIG. 8A is a top view of another example of an optical add-drop filter 100B having a conformal coupling configuration. A conformal coupling configuration can significantly reduce the insertion loss of an add-drop filter 100 and allows for feasible full spectral utilization of ultrawide FSR multi-mode resonator geometries which would otherwise be practically limited by the cumulative insertion loss.

The optical add-drop filter 100B includes a disk resonator 40, a first bus optical waveguide 23-1, and a second bus optical waveguide 23-2.

The disk resonator 40 has a circular shape and a radius of Rᵣ from a central point. In some implementations, the disk resonator 40 can have a radius in range from about 5 μm to 100 μm. For example, the disk resonator 40 can have a radius of at least about 5 μm, 10 μm, 20 μm, 30 μm, 40 μm, 50 μm, 60 μm, 70 μm, 80 μm, 100 μm, or more. The disk resonator 40 can have a radius of at most about 100 μm, 90 μm, 80 μm, 70 μm, 60 μm, 50 μm, 40 μm, 30 μm, 20 μm, 10 μm, 5 μm, or less.

The first 23-1 and second 23-2 bus waveguides are each evanescently coupled to the disk resonator 40 and configured similarly as the optical waveguide 23 shown in FIG. 5. Here, the second bus waveguide 23-2 is rotated 180 degrees relative the first bus waveguide 23-1 such that the negative adiabatic bend 10′-1 and 10′-2 of the first 23-1 and second 23-2 bus waveguides each share a common conformal point (P₀) that is coincident with the center point of the disk resonator 40. Hence, the disk resonator 40 is coaxial with the arcuate sections 14′-1 and 14′-2 and conformally coupled with the bus waveguides 23-1 and 23-2. Within the conformal angles (θ′) of the negative adiabatic bends 10′-1 and 10′-2, a distance (d_{c}) between the first profiles 15i-1 and 15i-2 of the first 23-1 and second 23-2 bus waveguides and an outer profile 41 of the disk resonator 40 specifies the coupling spacing. The arcuate sections 14′-1 and 14′-2 can be strongly evanescently coupled to the disk resonator 40 over a coupling length of about L_{c}=(R′+d_{c}/2)θ′. Note that the bus waveguides 23-1 and 23-2 can be single or multi-mode waveguides, which is particularly useful for angular phase matching when the disk resonator 40 is a multi-mode resonator.

As shown in FIG. 8A, the outer profile 41 of the disk resonator 40 and the second profiles 15o-1 and 15o-2 of the bus waveguides 23-1 and 23-2 bound the middle area 104 of the add-drop filter 100B, and the first profiles 15i-1 and 15i-2 of the bus waveguides 23-1 and 23-2 bound the outer areas 106-1 and 106-2 of the add-drop filter 100B. FIGS. 8B-8C are cross-sectional views (Section A-A′) of the disk-resonator add-drop filter 100B shown in FIG. 8A with different layer stack configurations. As shown in FIGS. 8B-8C, each of the middle area 104, first outer area 106-1, and second outer area 106-2 can be respectively filled with the ridge layer 115 to provide electrical contacts for the disk-resonator add-drop filter 100B. In FIG. 8B, the ridge layer 115 is omitted. In FIG. 7C, the ridge layer 115 fills each of the middle area 104, first outer area 106-1, and second outer 106-2.

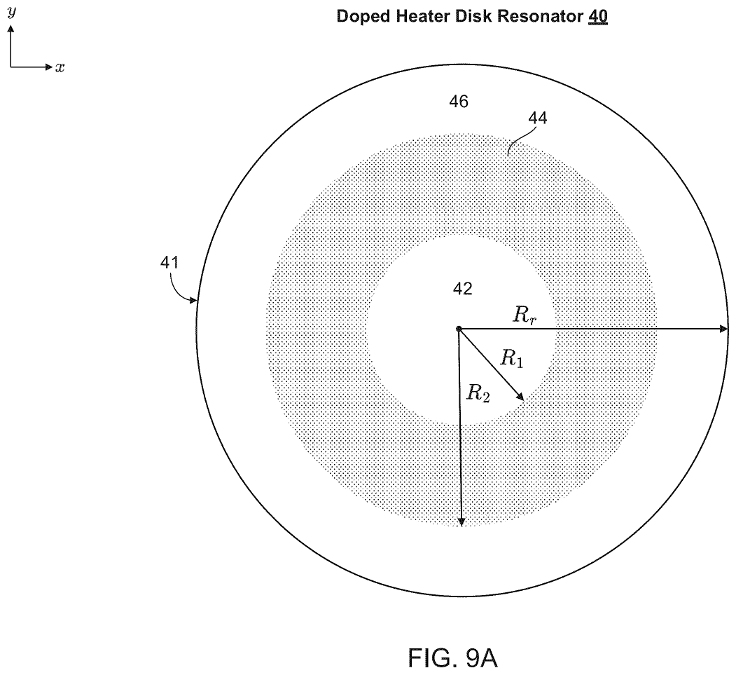

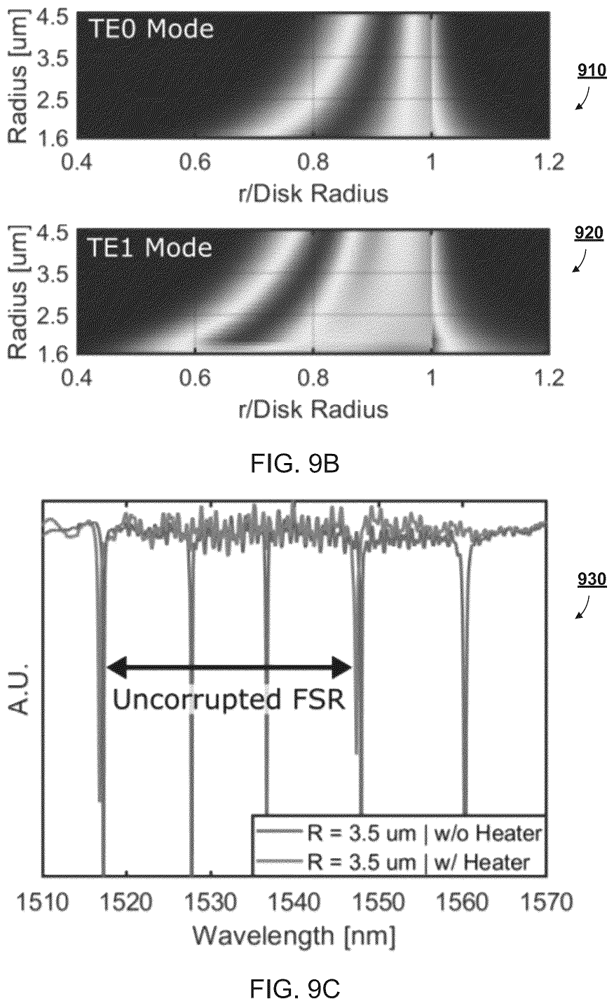

FIG. 9A is a top view of an example of the disk resonator 40 shown in FIG. 8A configured with a doped heater. Here, the disk resonator 40 can be a multi-mode resonator—high concentration contact doping is utilized to create radially dependent spatial loss and selectively suppress higher order modes of the disk resonator 40, preserving wide FSR. Note, for the doped heater disk resonator 40, the core layer 114 is typically composed of a semiconductor material, e.g., silicon or silicon nitride, to allow sufficient electrical conductivity via doping.

As shown in FIG. 9A, the disk resonator 40 has an inner circular area 42 with a radius of R₁, a middle annulus area 44 with an inner radius of R₁ and an outer radius of radius R₂, and an outer annulus area 46 with an inner radius of R₁ and an outer radius of Rᵣ. The middle annulus area 44 is doped with an n-type or p-type dopant while the inner circular area 42 and outer annulus area 46 are undoped. Examples of n-type dopants include, but are not limited to, phosphorus, arsenic, antimony, sulfur selenium, and tellurium. Examples of p-type dopants include, but are not limited to, boron, aluminum, gallium, and indium.

In some implementations, the middle annulus area 44 can have an inner radius in range from about 10 μm to 50 μm. For example, the inner radius of the middle annulus area 44 can be at least about 10 μm, 20 μm, 30 μm, 40 μm, 50 μm, or more. The inner radius of the middle annulus area 44 can be at most about 50 μm, 40 μm, 30 μm, 20 μm, 10 μm, or less. In some implementations, the middle annulus area 44 can have an outer radius in range from about 50 μm to 95 μm. For example, the outer radius of the middle annulus area 44 can be at least about 50 μm, 60 μm, 70 μm, 80 μm, 90 μm, 95 μm, or more. The outer radius of the middle annulus area 44 can be at most about 95 μm, 90 μm, 80 μm, 70 μm, 60 μm, 50 μm, or less.

FIG. 9B includes a plot 910 of a TE0 mode and a plot 920 of a TE1 mode confined in the doped heater disk resonator 40 shown in FIG. 9A. The plots 910 and 920 show the concentration of the TE0 and TE1 modes along the radial direction as a function of the radius of the disk resonator 40. FIG. 9C includes a plot 930 of modal spectrum of the doped heater disk resonator 40 shown in FIG. 9A. When electrical contacts are connected to the doped middle annulus area 44 of the disk resonator 40, and a voltage is applied, electrical current flows between the contacts resulting in resistive heating of the disk resonator 40. As shown in plot 930, this results in mode selective loss that effectively eliminates the TE0 or TE1 mode depending on the configuration of the disk resonator 40.

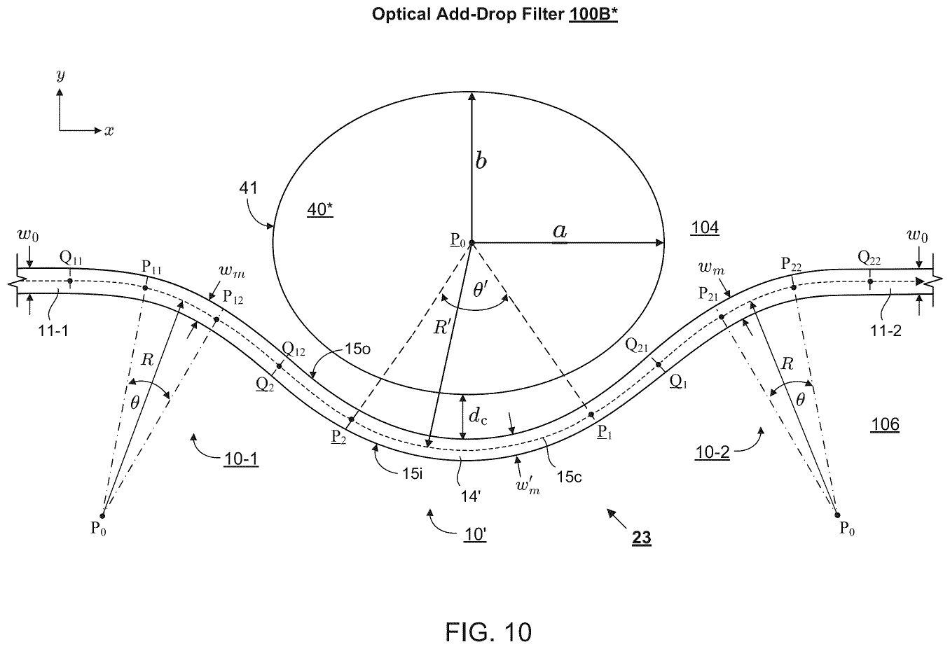

FIG. 10 is a top view of another example of the optical add-drop filter 100B* where the disk resonator 40 has been replaced with an elliptical disk resonator 40*. Note, only one of the two bus waveguides 23-1 and 23-2 is shown in FIG. 10 for clarity. Here, the elliptical disk-resonator add-drop filter 100B* is obtained by applying an ellipticity factor (∈) to the disk-resonator add-drop filter 100B, thereby elongating the disk-resonator add-drop filter 100B along the x-axis (or compressing the disk-resonator add-drop filter 100B along the y-axis). The resulting elliptical disk resonator 40* has a semi-major axis (a) along the x-axis and a semi-minor axis (b) along the y-axis, with an ellipticity factor given as

$$ϵ = \frac{a - b}{a} .$$

The common conformal point (P₀) of the negative adiabatic bends 10′-1 and 10′-2 is an intersection point of the semi-major and semi-minor axes.

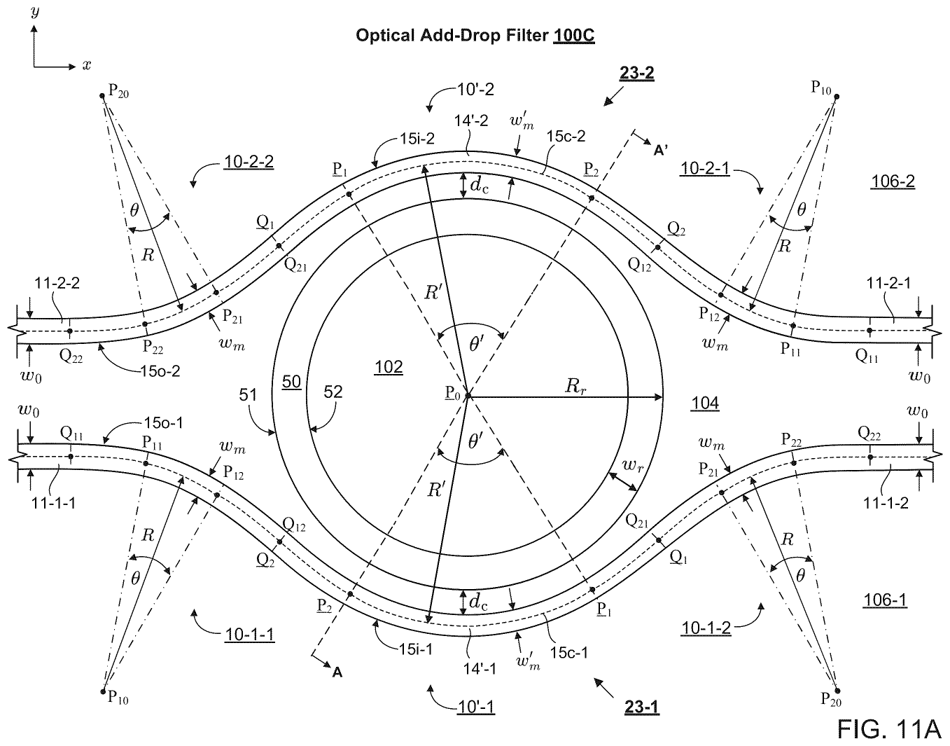

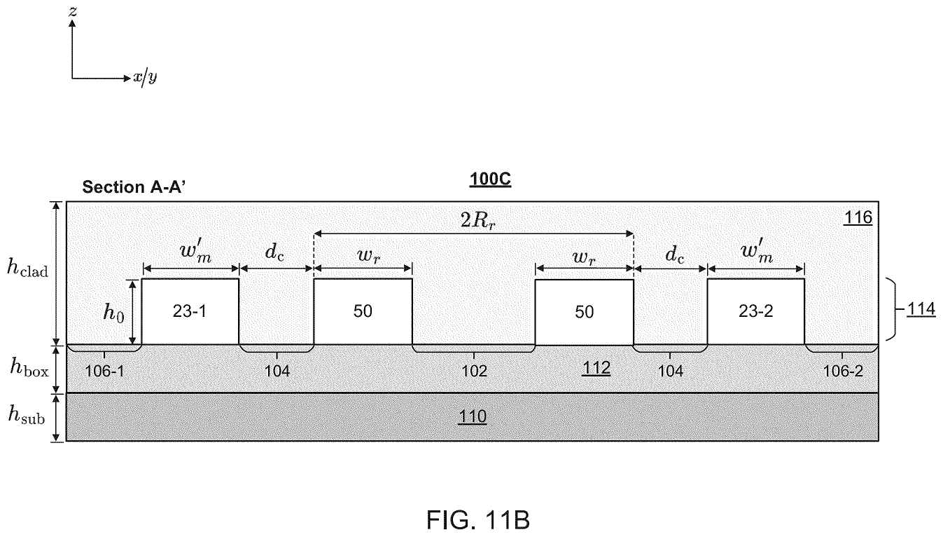

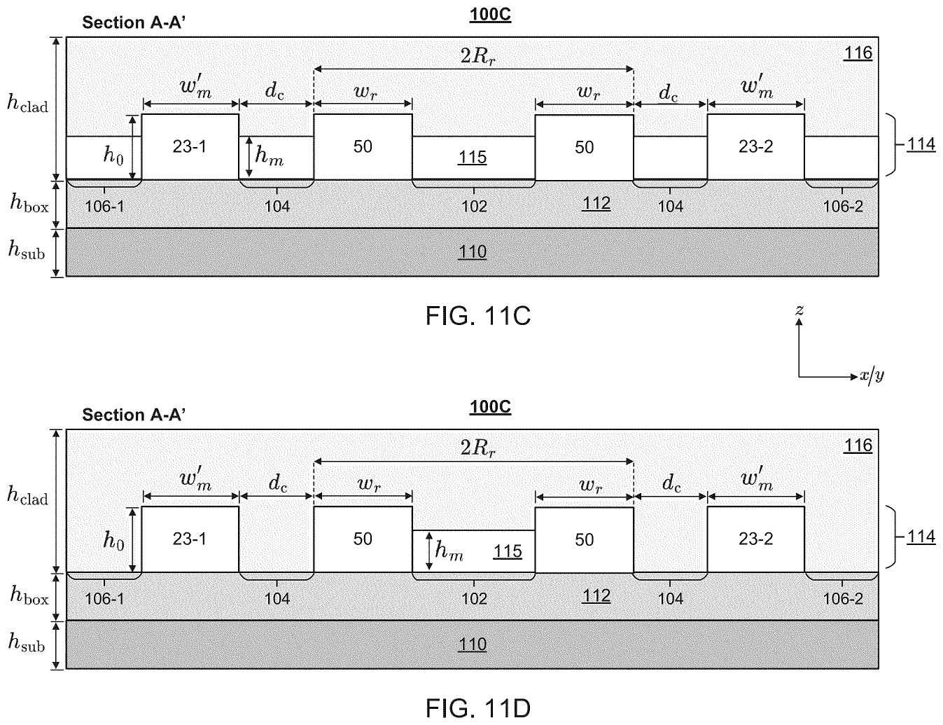

FIG. 11A is a top view of another example of an optical add-drop filter 100C having a conformal coupling configuration. The optical add-drop filter 100C includes a ring resonator 50 evanescently coupled and coaxial to the two bus waveguides 23-1 and 23-2. The ring-resonator add-drop filter 100C is configured similarly as the disk-resonator add-drop filter 100B of FIG. 8A except the disk resonator 40 has been replaced with the ring resonator 50.

The ring resonator 50 has an annulus shape, a radius of Rᵣ, a radial width of wᵣ, and a central point coincident with the common conformal point (P₀) of the negative adiabatic bends 10′-1 and 10′-2 of the bus waveguides 23-1 and 23-2. In some implementations, the ring resonator 50 can have a radius in range from about 1 μm to 100 μm. For example, the ring resonator 50 can have a radius of at least about 5 μm, 10 μm, 20 μm, 30 μm, 40 μm, 50 μm, 60 μm, 70 μm, 80 μm, 100 μm, or more. The ring resonator 50 can have a radius of at most about 100 μm, 90 μm, 80 μm, 70 μm, 60 μm, 50 μm, 40 μm, 30 μm, 20 μm, 10 μm, 5 μm, or less. In some implementations, the ring resonator 50 can have a radial width in a range from about 200 nm to 600 nm. For example, the ring resonator 50 can have a radial width of at least about 200 nm, 250 nm, 300 nm, 350 nm, 400 nm, 450 nm, 500 nm, 550 nm, 600 nm, or more. The ring resonator 50 can have a radial width of at most about 600 nm, 550 nm, 500 nm, 450 nm, 400 nm, 350 nm, 300 nm, 250 nm, 200 nm, or less.

As shown in FIG. 11A, an inner profile 52 of the ring resonator 50 encloses the middle area 102 of the add-drop filter 100c, an outer profile 51 of the ring resonator 50 and the second profiles 15o-1 and 15o-2 of the bus waveguides 23-1 and 23-2 bound the middle area 104 of the add-drop filter 100B, and the first profiles 15i-1 and 15i-2 bound the outer areas 106-1 and 106-2 of the add-drop filter 100B. FIGS. 11B-11D are cross-sectional views (Section A-A′) of the ring-resonator add-drop filter 100C shown in FIG. 11A with different layer stack configurations. As shown in FIGS. 11B-11D, each of the areas 102, 104, 106-1, and 106-2 can be respectively filled with the ridge layer 115 to provide electrical contacts for the ring-resonator add-drop filter 100C. In FIG. 11B, the ridge layer 115 is omitted. In FIG. 7C, the ridge layer 115 fills each of the inner area 102, middle area 104, first outer area 106-1, and second outer area 106-2 of the add-drop filter 100C. In FIG. 7D, the ridge layer 115 only fills the inner area 102 of the add-drop filter 100C.

### V. Examples of Polarization Splitter Rotators Utilizing Adiabatic Bends

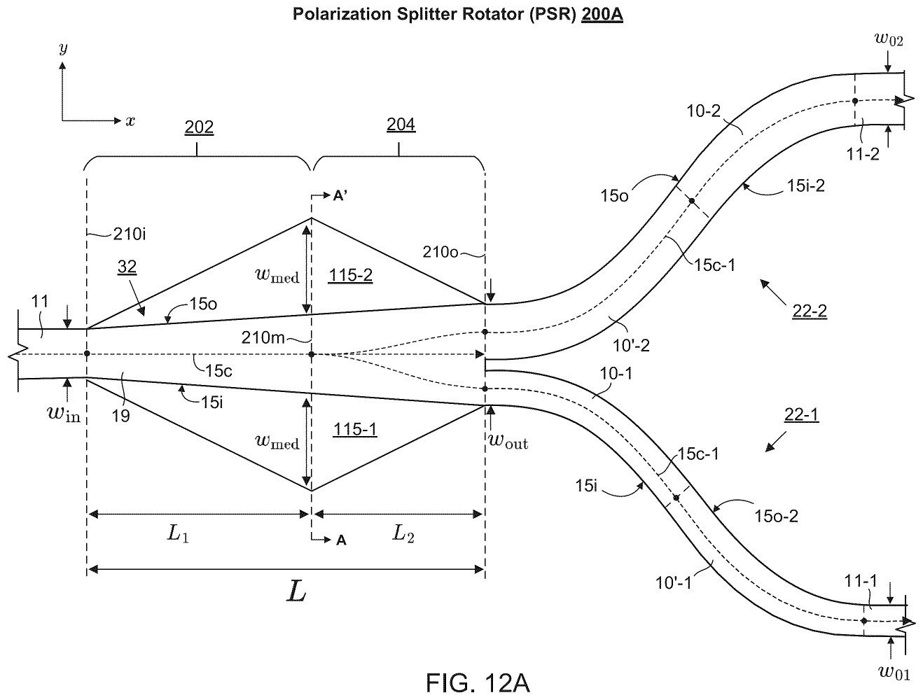

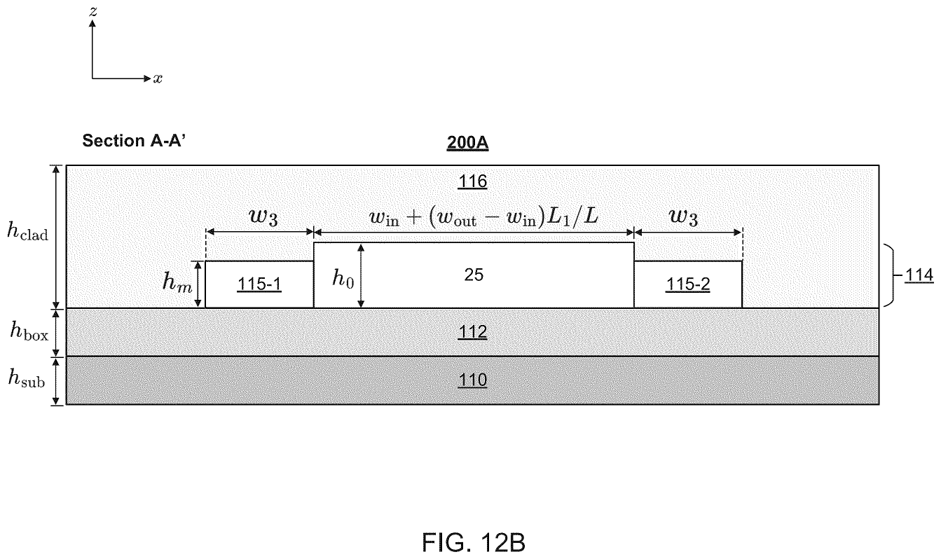

FIG. 12A is a top view of an example of a polarization splitter rotator (PSR) 200A. FIG. 12B is a cross-sectional view of the PSR 200A shown in FIG. 12A illustrating a layer stack configuration. For ease of description, reference will be made to both FIGS. 12A and 12B when describing the structure and operation of the PSR 200A.

As shown in FIG. 12A-12B, the PSR 200A includes an input optical waveguide 32, a first output optical waveguide 22-1, and a second output optical waveguide 22-2 connected to one another. The PSR 200A has a first profile 15i that is shared between the input waveguide 32 and the first output waveguide 23-1, and a second profile 15o that is shared between the input waveguide 32 and the second output waveguide 22-2. This creates a Y-branched configuration where the input waveguide 32 splits into the first 22-1 and second 23-2 output waveguides, such that a TE1 mode output from the input waveguide 32 preferentially couples into the first output waveguide 22-1 as a TE0 mode and a TE0 mode output from the input waveguide 32 preferentially couples into the second output waveguide 22-2. Here, the output waveguides 22-1 and 22-2 are asymmetric, having different curvatures and geometric parameters, thereby forming an asymmetric Y-branch. This type of Y-branch configuration can allow for high modal splitting efficiency while maintaining low optical losses.

The input waveguide 32 includes a linear section 11 and a tapered section 19 connected to each other. The tapered section 19 includes an input end 210i and an output end 210o that are parallel to each other and perpendicular to the geometric path 15c of the input waveguide 32. The linear section 11 is connected to the input end 210i of the tapered section 19, and the output waveguides 22-1 and 22-2 are each connected to the output end 210o of the tapered section 19.

The tapered section 19 acts as a mode rotator for the PSR 200A to rotate the polarization of light. The tapered section 19 achieves this through the gradual transformation of the input waveguide 32's cross-sectional geometry. Particularly, the tapered section 19 has a width w(s) that increases (e.g., linearly) with path length, from an input width (wᵢₙ) at the input end 210i to an output width (wₒᵤₜ) at the output end 210o, given as w(s)=wᵢₙ+(wᵢₙ−wₒᵤₜ)s/L. Here, L is the total length of the tapered section 19 measured between the input 210i and output 210o ends. Within the tapered section 19, the first 15i and second 15o profiles are symmetrical about the geometric path 15c. In other words, the first 15i and second 15o profiles have the same taper angle, e.g., in a range from about 0.5 degrees to 5 degrees, within the tapered section 19.

In general, the total length and other parameters of the tapered section 19 depends on the material system. That being said, in some implementations, the tapered section 19 can have a total length in range from about 10 μm to 200 μm. For example, the tapered section 19 can have a total length of at least about 10 μm, 20 μm, 30 μm, 40 μm, 50 μm, 100 μm, 150 μm, 200 μm, or more. The tapered section 19 can have a total length of at most about 200 μm, 150 μm, 100 μm, 50 μm, 40 μm, 30 μm, 20 μm, 10 μm, or less. The tapered section 19 can have an input width in a range from about 200 nm to 600 nm. For example, the tapered section 19 can have an input width of at least about 200 nm, 250 nm, 300 nm, 350 nm, 400 nm, 450 nm, 500 nm, 550 nm, 600 nm, or more. The tapered section 19 can have an input width of at most about 600 nm, 550 nm, 500 nm, 450 nm, 400 nm, 350 nm, 300 nm, 250 nm, 200 nm, or less. The tapered section 19 can have an output width in a range from about 500 nm to 1,500 nm. For example, the tapered section 19 can have an output width of at least about 500 nm, 600 nm, 700 nm, 800 nm, 900 nm, 1,000 nm, 1,100 nm, 1,200 nm, 1,300 nm, 1,400 nm, 1,500 nm, or more. The tapered section 19 can have an output width of at most about 1,500 nm, 1,400 nm, 1,300 nm, 1,200 nm, 1,100 nm, 1,000 nm, 900 nm, 800 nm, 700 nm, 600 nm, 500 nm, or less.

As shown in FIGS. 12A-12B, the PSR 200A further includes a first ridge layer 115-1 and a second ridge layer 115-2. The first ridge layer 115-1 bounds the first profile 15i of the input waveguide 32 between the input 210i and output 210o ends of the tapered section 19. The second ridge layer 115-2 bounds the second profile 15o of the input waveguide 32 between the input 210i and output 210o ends of the tapered section 19. The first 115-1 and second 115-2 ridge layers are symmetric about the geometric path 15c of the input waveguide 32.

An intermediate line 210m is parallel to the input 210i and output 210o ends of the tapered section 19, and arranged between the input 210i and output 210o ends. The intermediate line 210 sections the PSR 200A into a first region 202 and a second region 204 that together form a mode converter of the PSR 200A that converts a TM0 mode into the TE1 mode travelling along the geometric path 15c of the input waveguide 32, while leaving the TE0 mode unaffected.

Within the first region 202, a width wₑ(s) of each of the first 115-1 and second 115-2 ridge layers increases (e.g., linearly) with path length, from zero at the input end 210i of the tapered section 19 to an intermediate width (w_{med}) at the intermediate line 210m, given as wₑ(s)=w_{med}s/L₁. Here, L₁ is the total length of the MC region 202 measured from the input end 210i of the tapered section 19 to the intermediate line 210m. In some implementations, the MC region 202 can have a total length in range from about 5 μm to 150 μm. For example, the MC region 202 can have a total length of at least about 5 μm, 10 μm, 20 μm, 30 μm, 40 μm, 50 μm, 100 μm, 150 μm, or more. The MC section 19 can have a total length of at most about 150 μm, 100 μm, 50 μm, 40 μm, 30 μm, 20 μm, 10 μm, 5 μm, or less.

Within the second region 204, the width of each of the first 115-1 and second 115-2 ridge layers decreases (e.g., linearly) with path length, from the intermediate width at the intermediate line 210m to zero at the output end 210o of the tapered section 19, given as

$${w}_{e} ( s ) = {w}_{med} ( 1 - \frac{s}{{L}_{2}} ) .$$

Here, L₂ is the total length of the MMI region 204 measured from the intermediate line 210m to the output end 210o of the tapered section 19. In some implementations, the MC region 202 can have a total length in range from about 5 μm to 150 μm. For example, the MC region 202 can have a total length of at least about 5 μm, 10 μm, 20 μm, 30 μm, 40 μm, 50 μm, 100 μm, 150 μm, or more. The MC section 19 can have a total length of at most about 150 μm, 100 μm, 50 μm, 40 μm, 30 μm, 20 μm, 10 μm, 5 μm, or less.

The output waveguides 22-1 and 22-2 are each of the type shown in FIG. 4 with a diverted geometric path 15c-1 and 15c-2, but asymmetric both in sense of curvature and geometric parameters, e.g., effective bending angles, effective bending radii, conformal angles, arcuate radii, operational widths, auxiliary widths, etc. Particularly, the first output waveguide 22-1 includes a positive adiabatic bend 10-1, a negative adiabatic bend 10′-1, and a linear section 11-1 serially connected to one another, where the positive adiabatic bend 10-1 is connected to the output end 210o of the input waveguide 32. Conversely, the second output waveguide 22-1 includes a negative adiabatic bend 10′-2, a positive adiabatic bend 10-2, and a linear section 11-2 serially connected to one another, where the negative adiabatic bend 10′-2 is connected to the output end 210o of the input waveguide 32. This configuration causes the output waveguides 22-1 and 22-2 to divert in opposite directions along the y-axis. Moreover, the first output waveguide 22-1 has an operational width of w₀₁, and the second output waveguide 22-1 has an operational width of w₀₂>w₀₁, which can be an important parameter for robust operation of the PSR 200.

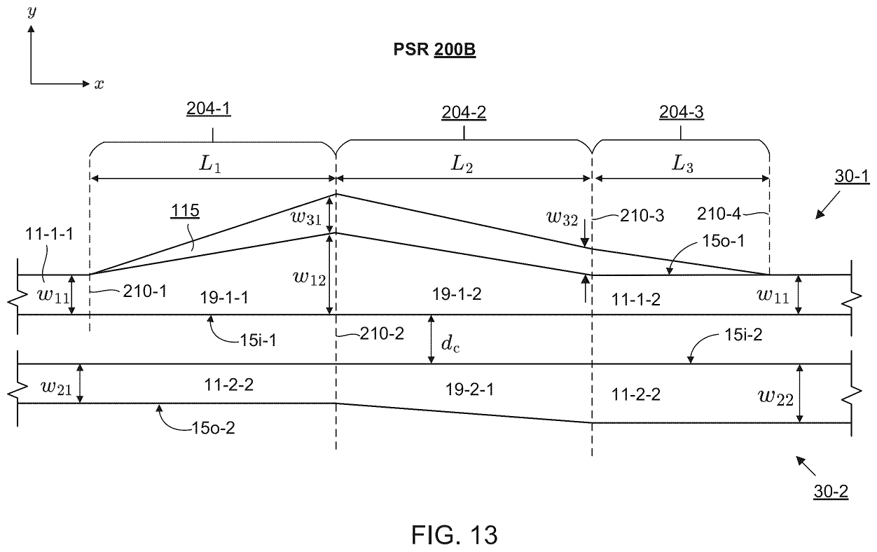

FIG. 13 is a top view of another example of a PSR 200B. The PSR 200B includes a first bus optical waveguide 30-1 and a second bus optical waveguide 30-2 evanescently coupled to each other. Here, before the TE0 and TM0 modes enter the first bus waveguide 30-1, each of the TE0 and TM0 modes is rotated adiabatically into “mode1” and “mode2” in an L-shaped optical waveguide. The mode that started as TM0 is then adiabatically coupled into TE0 of the second bus waveguide 30-2, while the mode that started as TE0 remains unaffected.

As shown in FIG. 13, the PSR 200B is sectioned into three regions 204-1, 204-2, and 204-3 by four lines 210-1, 210-2, 210-3, and 210-4 that are parallel to one another. The first region 204-1 corresponds to the area of the PSR 200B between the first 210-1 and second 210-2 lines and has a total length of L₁. The second region 204-2 corresponds to the area of the PSR 200B between the second 210-2 and third 210-3 lines and has a total length of L₂. The third region 204-2 corresponds to the area of the PSR 200B between the third 210-2 and third 210-3 lines and has a total length of L₃.

The first profiles 15i-1 and 15i-2 of the bus waveguides 30-1 and 30-2 are parallel to each other and orthogonal to each of the lines 210-1, 210-2, 210-3, and 210-4. The distance between the first profiles 15i-1 and 15i-2 specifies the coupling spacing (d_{c}) with a total coupling length of about L_{c}=L₁+L₂+L₃. Conversely, the second profiles 15o-1 and 15o-2 of the bus waveguides 30-1 and 30-2 are tapered at various angles, thus the bus waveguides 30-1 and 30-2 are asymmetric. This configuration can enable strong evanescent coupling, phase matching, and fabrication tolerance as a constant coupling spacing is maintained between the bus waveguides 30-1 and 30-2. Note, due to the asymmetry and sharp corners of the tapers, the geometric path 15c of the bus waveguides 30-1 and 30-2 is omitted in FIG. 13 and the description of the PSR 200B.

The first bus waveguide 30-1 includes a first linear section 11-1-1, a first tapered section 19-1-1, a second tapered section 19-1-2, and a second linear section 11-1-2 serially connected to one another. The first linear section 11-1-1 has a constant width equal to a first width (w₁₁) and extends to the first line 210-1. The first tapered section 19-1-1 is defined within the first region 204-1 and extends from the first line 210-1 to the second line 210-2. The first tapered section 19-1-1 has a width that increases linearly from the first width (w₁₁) at the first line 210-1 to a second width (w₁₂) at the second line 210-2. The second tapered section 19-1-2 is defined within the second region 204-2 and extends from the second line 210-2 to the third line 210-3. The second tapered section 19-1-2 has a width that decreases linearly from the second width (w₁₂) at the second line 210-2 to the first width (w₁₁) at the third line 210-3. The second linear section 11-1-2 has a constant width equal to the first width (w₁₁) and extends from the third line 210-3.

The second bus waveguide 30-2 includes a first linear section 11-2-2, a tapered section 19-2-1, and a second linear section 11-1-2 serially connected to one another. The first linear section 11-2-1 has a constant width equal to a first width (w₂₁) and extends to the second line 210-2. The tapered section 19-2-1 is defined within the second region 204-2 and extends from the second line 210-2 to the third line 210-3. The tapered section 19-2-1 has a width that increases linearly from the first width (w₂₁) at the second line 210-2 to a second width (w₂₂) at the third line 210-3. The second linear section 11-2-2 has a constant width equal to the second width (w₂₂) and extends from the third line 210-3.

The ridge layer 115 bounds the second profile 15o-2 of the first bus waveguide 30-1 between the first 210-1 and fourth 210-4 lines. The ridge layer 115 is defined within each of the first 204-1, second 204-2, and third 204-3 regions and has a similar tapered geometry as the bus waveguides 30-1 and 30-2. Within the first region 204-1, the width of the ridge layer 115 increases linearly from zero at the first line 210-1 to a first width (w₃₁) at the second line 210-2. Within the second region 204-2, the width of the ridge layer 115 decreases from the first width (w₃₁) at the second line 210-2 to a second width (w₃₂) at the third line 210-3. Within the third region 204-3, the width of the ridge layer 115 decreases linearly from the second width (w₃₂) at the third line 210-3 to zero at the fourth line 210-4.

### VI. Examples of Optical Taps Utilizing Adiabatic Bends

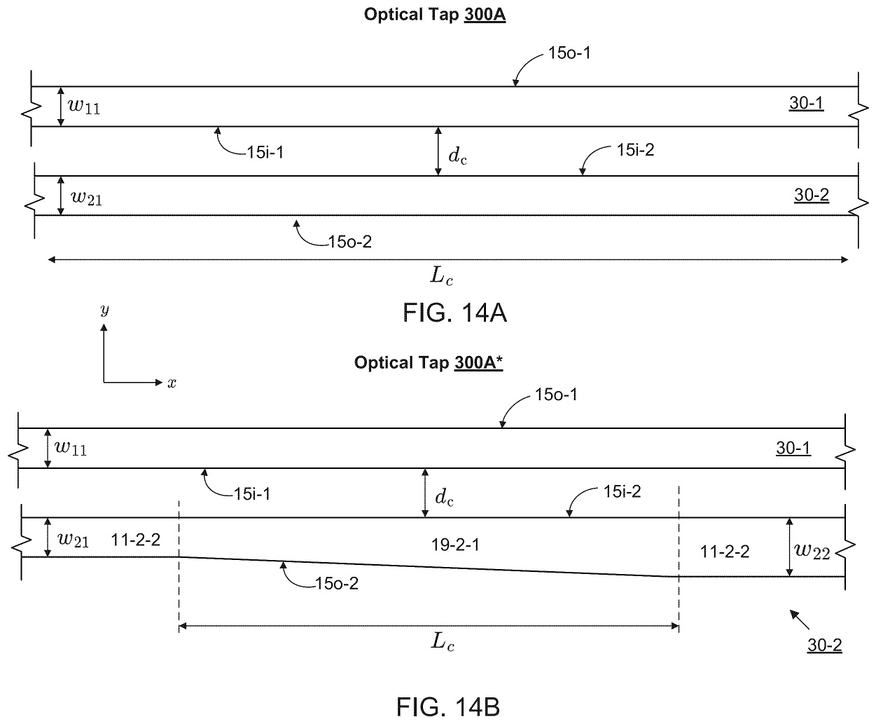

FIG. 14A is a top view of an example of an optical tap 300A. The optical tap 300A includes a first bus optical waveguide 30-1 and a second bus optical waveguide 30-2 evanescently coupled to each other. The bus waveguides 30-1 and 30-2 are linear and parallel with each other. The bus waveguides 30-1 and 30-2 have the same length L_{c} but differing widths w₁₁ and w₂₁. Hence, the bus waveguides 30-1 and 30-2 are asynchronous with different propagation numbers #1 and l₂, that depend on their respective widths. As the coupling length (L_{c}) changes, the maximum coupling strength also changes. Particularly, as Δβ=β₁−β₂ increases, the maximum coupled decreases from 100%. If Δβ is set such that a full coupling length produces the desired tap ratio, then the result is an optical tap 300A with no first-order dependence on wavelength.

FIG. 14B is a top view of another example of the optical tap 300A*. Here, the second bus waveguide 30-2 now includes a first linear section 11-2-1, a tapered section 19-2-1, and a second linear section 12-2-2 serially connected to one another. The tapered section 19-2-1 has a width that increases linearly from a first width (w₂₁) of the first linear section 11-2-1 to a second width w₂₂ of second linear section 11-2-2 over the coupling length (L_{c}). The optical tap 300A* is configured similarly as the optical tap 300A of FIG. 14A but the taper of the second bus waveguide 30-2 further flattens the wavelength spectrum.

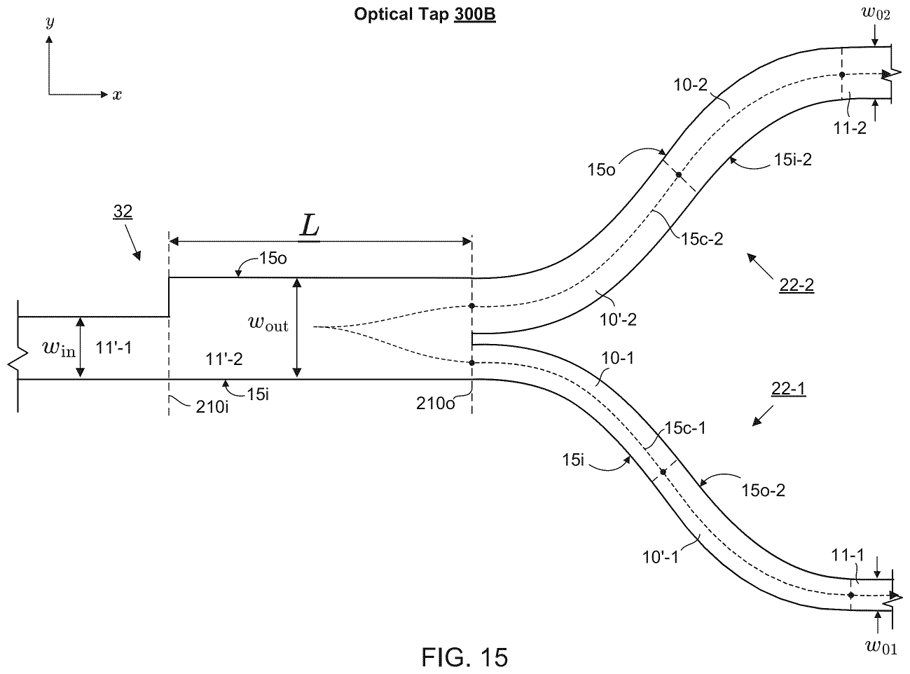

FIG. 15 is a top view of another example of an optical tap 300B. The optical tap 300B is configured similarly as the PSR 200A of FIGS. 12A-12B except the geometry of the input waveguide 32 has been modified. Here, the input waveguide 32 includes a first linear section 11′-1 with a constant width equal to the input width (wᵢₙ) and a second linear section 11′2 with a constant width equal to the output width (wₒᵤₜ). As shown in FIG. 15, the first profile 15i is continuous along the input waveguide 32 but the second profile 15o is discontinuous between the first 11′-1 and second 12′-2 linear sections. This sudden asymmetric increase from the input width to the output width converts a certain percentage of the TE0 mode to a TE1 mode. As described above, the asymmetric Y-branch configuration then converts the TE1 mode into a TE0 mode propagating preferentially in the first output waveguide 22-1, and the TE0 mode is directed preferentially to the the second output waveguide 22-2.

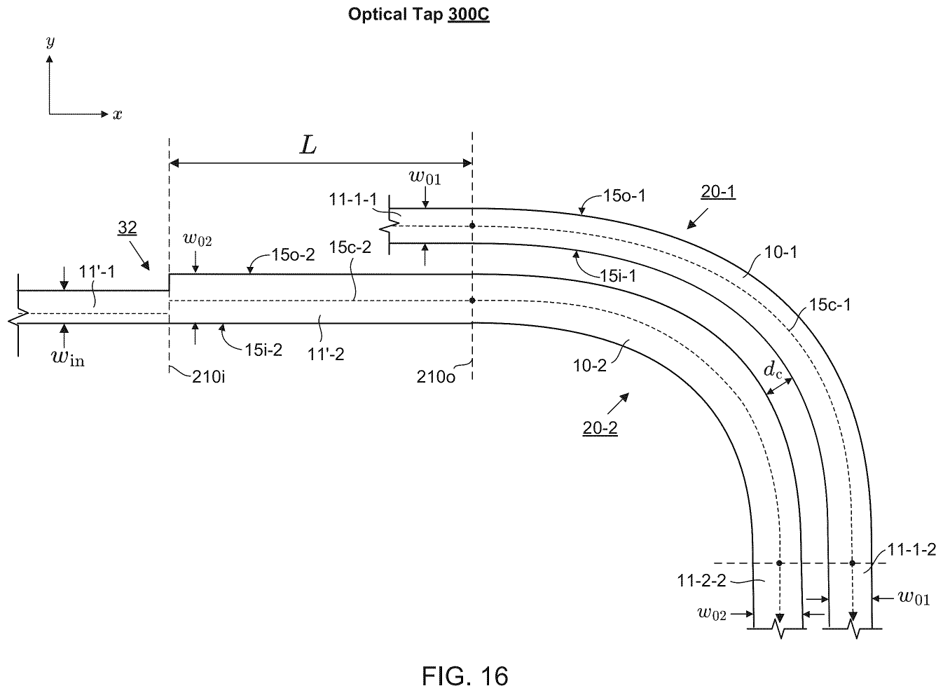

FIG. 16 is a top view of another example of an optical tap 300C. The optical tap 300C is configured similarly as the optical tap 300B of FIG. 15 except the Y-branched output waveguides 22-1 and 22-2 have each been supplemented with optical waveguides 20-1 and 20-2 of the type shown in FIGS. 2A-2B. Instead of splitting the TE0 and TE1 modes, the output waveguides 20-1 and 20-2 are evanescently coupled to each other to transfer the modes therebetween. Here, the second output waveguide 20-1 includes an adiabatic bend 10-2 connected to the second linear section 11′-2 of the input waveguide 32. The first output waveguide 20-1 also includes an adiabatic bend 10-1 and runs parallel to the second optical waveguide 20-2. The adiabatic bends 10-1 and 10-2 share a common conformal point and thus are conformally coupled to each other as described above, see FIGS. 6-1 and 6-2 for example. In this case, the TE0 mode is still propagated along the second optical waveguide 20-2, but the TE0 mode is transferred to the first optical waveguide 20-1 via the conformal coupling.

### VII. Examples of Optical Wave-Division Multiplexing Filters Utilizing Adiabatic Bends

FIG. 16 is a top view of an example of an optical wave-division multiplexing filter (WDM) filter 400. The optical WDM filter 400 includes an input optical waveguide 22-1, an output optical waveguide 22-1, and a grated optical waveguide 34 connected to one another.

The optical WDM filter 200A has a first profile 15i that is shared between the output waveguide 22-1 and the grated waveguide 34, and a second profile 15o that is shared between the grated waveguide 34 and the input waveguide 22-2. Analogous to the PSR 200A of FIGS. 12A-12B, this creates an asymmetric Y-branch between the input 22-1 and output 22-2 waveguides. However, for the optical WDM filter 400, the input waveguide 22-2 propagates a multiplexed input signal. The multiplexed signal includes multiple optical signals at multiple respective wavelengths λ₁, λ₂, . . . , λ_{N}. For example, the multiplexed signal can include 2, 3, 4, 5, 6, 7, 8, 16, 32, 64, or more different wavelengths discretely spaced within a desired optical band. The multiplexed signal is delivered to an input end 412 of the input waveguide 22-1 in a TE0 mode and then passes through an input end 410i of the grated waveguide 34.

The grated waveguide 34 is configured as a mode-converting grating reflector that is tuned to a first (λ₁) of the wavelengths via an applied voltage to the ridge layer 115 bounding the grated waveguide 34. Alternatively, or in addition, the ridge layer 115 may also be disposed on top of the grated waveguide 34. The optical signal at the first wavelength is converted from the TE0 mode into a TE1 mode as it is reflected by the grated waveguide 34, which is propagated backwards by the output waveguide 22-2, thereby filtering the first wavelength. The remaining optical signals at wavelengths λ₂, . . . , λ_{N} then pass to an output end 410o of the grated waveguide 34. Using this configuration, the output end 410o can then be connected to an input end 412 of another optical WDM filter 400 that has a grated waveguide 34 tuned to a second (λ₂) of the wavelengths, e.g., via an applied voltage to the ridge layer 115, thereby filtering the second wavelength in the same manner. This can proceed for each of the λ₁, λ₂, . . . , λ_{N} having N optical WDM filters 400 serially connected to one another.

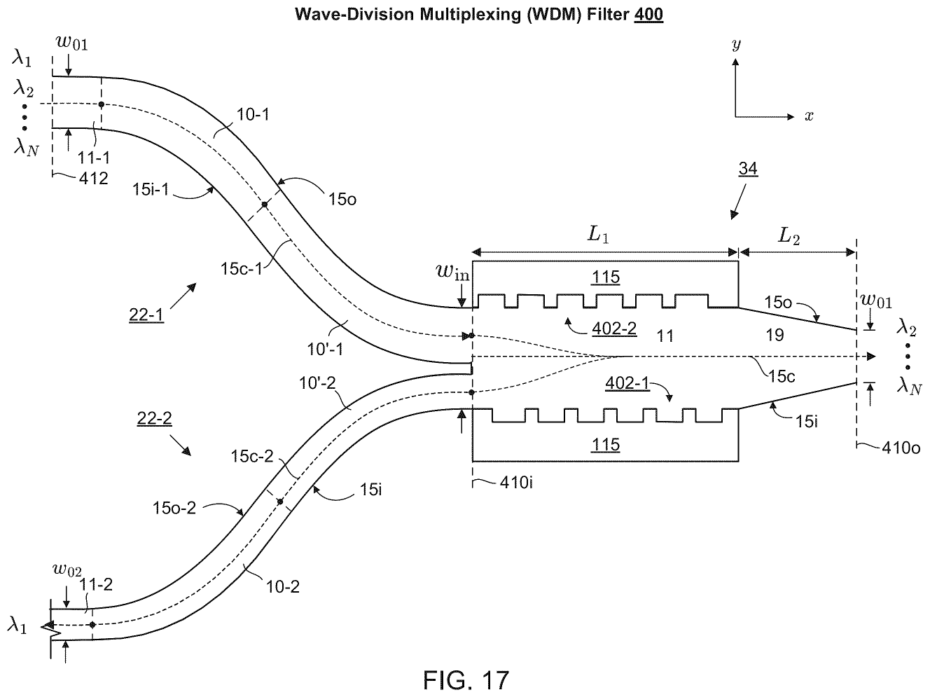

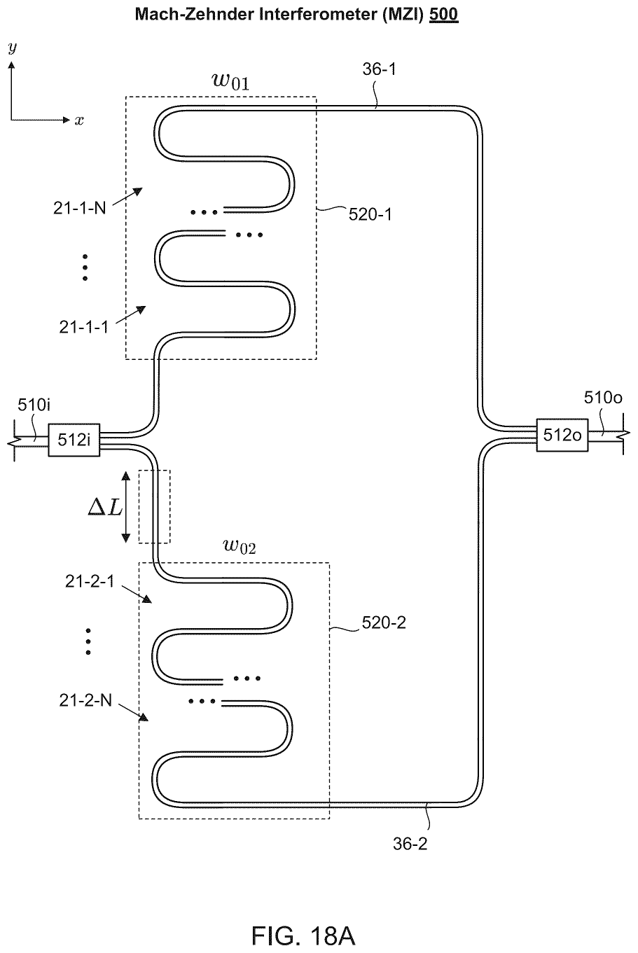

As shown in FIG. 17, the grated waveguide 34 includes a linear section 11 and a tapered section 19 connected to each other. The linear section 11 has an input width (wᵢₙ) corresponding to the width of the input end 410i of the grated waveguide 34. Within the linear section 11, the first 15i and second 15o profiles each include a respective grating 402-1 and 402-2 that is bounded by the ridge layer 115 to provide electrical or thermal tunability. The gratings 402-1 and 402-2 are periodic rows of rectangular or sinusoidal teeth that are 180 degrees out of phase with each other to enable the mode-converting reflection operation. The gratings 402-1 and 402-2 can also be apodized for adjusting the shape of the grated waveguide 34's passband. The tapered section 19 has a width that decreases linearly from the input width to an output width (w₀₁) at the output end 410o of the grated waveguide 34, where the output width equals the operational width of the input waveguide 22-1.

The input 22-1 and output 22-2 waveguides are each of the type shown in FIG. 4 with a diverted geometric path 15c-1 and 15c-2, but asymmetric both in sense of curvature and geometric parameters, e.g., effective bending angles, effective bending radii, conformal angles, arcuate radii, operational widths, auxiliary widths, etc. Particularly, the input waveguide 22-1 includes a positive adiabatic bend 10-1, a negative adiabatic bend 10′-1, and a linear section 11-1 serially connected to one another, where the positive adiabatic bend 10-1 is connected to the input end of the grated waveguide 34. Conversely, the output waveguide 22-2 includes a negative adiabatic bend 10′-2, a positive adiabatic bend 10-2, and a linear section 11-2 serially connected to one another, where the negative adiabatic bend 10′-2 is connected to the input end of the grated waveguide 34. This configuration causes the output waveguides 22-1 and 22-2 to divert in opposite directions along the y-axis. The input waveguide 22-1 has an operational width of w₀₁, and the second output waveguide 22-1 has an operational width of w₀₁>w₀₂, which can be an important parameter for robust operation of the optical WDM filter 400.

### VIII. Examples of Optical Mach-Zehnder Interferometers Utilizing Adiabatic Bends

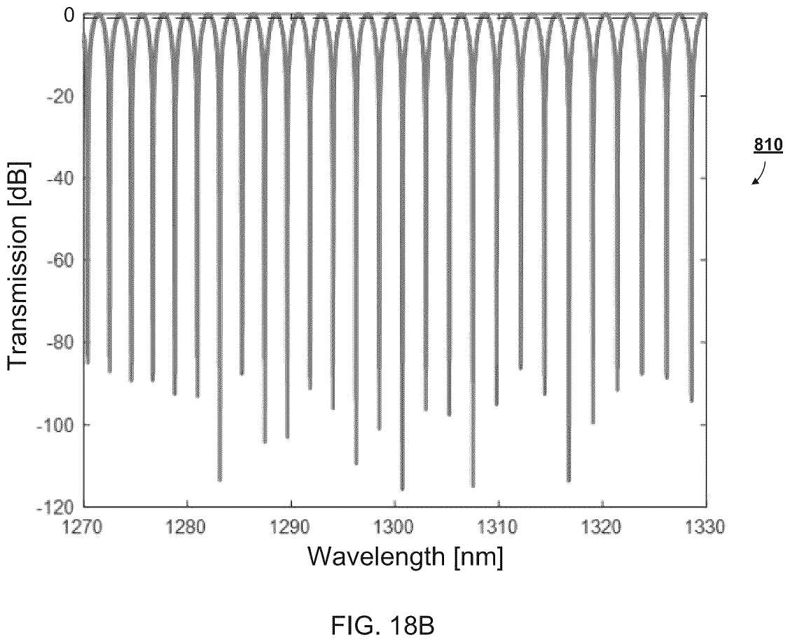

FIG. 18A a top view of an example of an optical Mach-Zehnder Interferometer (MZI) 500. In some implementations, the MZI 500 can designed as an athermal MZI (AMZI) that is temperature-insensitive.

The MZI 500 includes an input optical waveguide 510i, an optical splitter 512i, a first optical waveguide 36-1, a second optical waveguide 36-2, an optical combiner 512o, and an output optical waveguide 510o. Note, in some implementations, the output waveguide 510o can be substituted can be an output coupler, e.g., a 2×2 input/output device where the optical signal is routed to one output port or the other depending on the wavelength (and can be switched, etc.)

The splitter 512i, e.g., a Y-branch splitter, is connected to the input waveguide 510i and splits the input waveguide 510i into the first 36-1 and second 36-2 waveguides. The combiner 512o, e.g., a Y-branch combiner, is connected to the first 36-1 and second 36-2 waveguides and combines them into the output waveguide 510o. Hence, an optical signal propagating from the input waveguide 510i to the output waveguide 510o is split into two optical signals and recombined with some amount of constructive or deconstructive interference. Particularly, the first waveguide 36-1 has a total length of L₁, and the second waveguide 36-2 has a total length of L₂. The difference between their lengths ΔL=L₂−L₁>0 is chosen to create a phase shift for light propagating within the second waveguide 36-2. The phase difference (Δϕ) between the first 36-1 and second 36-2 waveguides is about equal to

$$Δ ϕ = \frac{2 π {n}_{eff} Δ L}{λ} ,$$

where λ is the operating wavelength.

Here, the waveguides 36-1 and 36-2 have the same nominal operational width (w₀) except for in two regions 520-1 and 520-2 of the MZI 500. In the first region 520-1, the first waveguide 36-1 has an operational width (w_01) that is less than the nominal operational width, w₀₁<w₀. Moreover, within the first region 520-1, the first waveguide 36-1 follows a tortuous, serpentine path constructed from multiple optical waveguides 21-1-1 thru 21-1-N of the type shown in FIG. 3. Each hairpin turn of the first waveguide 36-1 is implemented with a respective positive 10 or negative 10′ adiabatic bend with a 180-degree effective bending angle. Similarly, in the second region 520-2, the second waveguide 36-2 has an operational width (w_02) that is greater than the nominal operational width, w₀₂>w₀. Within the second region 520-1, the second waveguide 520-1 also follows a tortuous, serpentine path constructed from multiple optical waveguides 21-2-1 thru 21-2-N of the type shown in FIG. 3. Each hairpin turn of the second waveguide 36-2 is implemented with a respective positive 10 or negative 10′ adiabatic bend with a 180-degree effective bending angle. Note, that the benefit of the adiabatic bends 10 and 10′ is that they are much more compact than radial bends for the same amount of bending loss and, thus, a structure with the circuitous path shown in FIG. 18A is much smaller using the adiabatic bends 10 and 10′.

FIG. 18B includes a plot 810 of transmission versus wavelength of the MZI 500 shown in FIG. 18A at two different temperatures. As shown in the plot 810, the spectral peaks at the two temperatures are coincident (or almost coincident) indicating that the MZI 500 temperature-insensitive. Temperature insensitivity is achieved by matching the thermo-optic coefficient (TOC) of the first 36-1 and second 36-2 waveguides while preserving the specified phase difference between the two. This is accomplished by the varying widths and modes of the waveguides 36-1 and 36-2. Higher sensitivity with low optical loss is enabled by the adiabatic bends 10 and 10′ that allow for increased lengths of the waveguides 36-1 and 36-2 in a compact form factor. This can be particularly useful for silicon-based photonic circuits as silicon is inherently challenged by temperature drift, primarily due to silicon's high TOC. For example, temperature variations in traditional MZIs can lead to false-positive signals in sensing applications, significantly affecting their reliability.

In addition, the MZI 500 can also be configured for flat top and sharp roll-off, filtering of selected bands, and compactly routing multimode waveguides 36-1 and 36-2 with negligible insertion loss (IL) and parasitic coupling. The MZI 500 can employ the same material for both waveguides 36-1 and 36-2 widths such as silicon or silicon nitride. A dual-material implementation of the MZI 500 can also be employed that combines silicon and silicon nitride to mitigate phase variations induced by temperature changes. The tight bends permit compact form factors for the MZI 500, resulting in reduced footprint and higher bandwidth densities.

### IX. Additional Examples of Optical Components

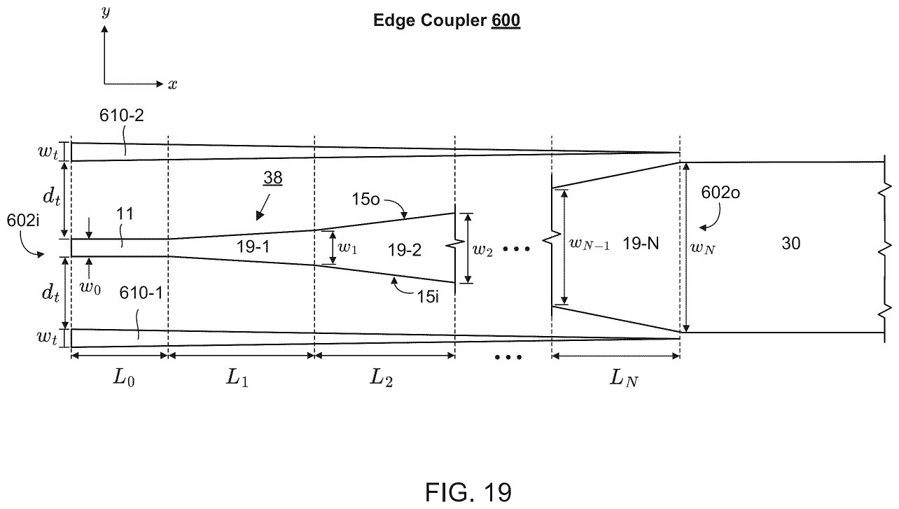

FIG. 19 is a top view of an example of an optical edge coupler 600, e.g., a multi-stage trident edge coupler. In general, there are two main coupling techniques to couple light to a photonics chips: a grating coupler, or an edge coupler. Edge couplers are advantageous as they typically have lower polarization-dependent loss (PDL) and less wavelength sensitivity than grating couplers. However, alignment tolerance and mode-mismatch are some of the issues with currently available edge couplers, particularly those that include only one tip. Using multiple linear or nonlinear tapers, the multi-stage configuration of the edge coupler 600 expands the mode to improve mode matching, increase alignment tolerance. The multistage configuration results in more compact device length. For example, the edge coupler 600 can be used for either laser to the chip light coupling or fiber to the photonics chip IO.

As shown in FIG. 19, the edge coupler 600 includes an input optical waveguide 38 and two coupler tips 610-1 and 610-1. Here, the input waveguide 38 is connected to a bus optical waveguide 30, e.g., for propagating an input optical signal into a bulk of photonic integrated device 5.

The input waveguide 38 is a multi-stage waveguide including a linear section 11-1 and multiple tapered sections 19-1 thru 19-N serially connected to one another from an input end 602i to an output end 602o of the edge coupler 600. The linear section 11 has a length of L₀ and a width of w₀, corresponding to the input width of the input waveguide 38. The bus waveguide 30 has a width of w_{N}, corresponding to the output width of the input waveguide 38. Each tapered section 19-1, 19-2, thru 19-N has a respective length of L₁, L₂, . . . , L_{N} and a width that increases linearly or nonlinearly from wₙ₋₁ to wₙ, where n=1, 2, . . . , N indexes the tapered section 19. For linear tapers, the width of a tapered section 19 is given as

$$w ( s ) = {w}_{n - 1} + \frac{( {w}_{n} - {w}_{n - 1} ) s}{{L}_{n}} .$$

Moreover, the tapered sections 19-1 thru 19-N have increasing sharper tapers, that is, larger taper angles (or slopes) from the input end 602i to the output end 602o. This implies

$$\frac{{w}_{n} - {w}_{n - 1}}{{L}_{n}} > \frac{{w}_{n - 1} - {w}_{n - 2}}{{L}_{n - 1}}$$

for linear tapers.

The first coupler hip 610-1 is arranged on a first side of the input waveguide 38 a distance of dₜ from the linear section 11 of the input waveguide 38. The first coupler tip 610-1 is positioned between the input 602i and output 602o ends of the edge coupler 600 and is adjacent the first profile 15i of the input waveguide 38. The first coupler tip 610-1 is a tapered tip and has a width that decreases linearly from a tip width (wₜ) at the input end 602i to zero width at the output end 602o. Similarly, the second coupler tip 610-2 is arranged on a second, opposite side of the input waveguide 38 a distance of dₜ from the linear section 11 of the input waveguide 38. The second coupler tip 610-2 is positioned between the input 602i and output 602o ends of the edge coupler 600 and is adjacent the second profile 15o of the input waveguide 38. The second coupler tip 610-2 is a tapered tip and has a width that decreases linearly from a tip width (wₜ) at the input end 602i to zero width at the output end 602o.

### Other Embodiments

In addition to the embodiments of the attached claims and the embodiments described above, the following numbered embodiments are also innovative.

1. A waveguide having a geometric path defined in a plane and a width perpendicular to the geometric path, wherein the geometric path comprises an adiabatic curve connecting a first inflection point to a second inflection point on the geometric path, the adiabatic curve comprising: a circular arc subtending an angle from a first endpoint to a second endpoint, wherein the width of the waveguide is equal to a first width along the circular arc; a clothoid connecting the first inflection point to the first endpoint of the circular arc, wherein the width of the waveguide increases from a second, different width to the first width along the clothoid; and an anti-clothoid connecting the second endpoint of the circular arc to the second inflection point, wherein the width of the waveguide decreases from the first width to a third width along the anti-clothoid.
2. The waveguide of embodiment 1, wherein the adiabatic curve subtends a bending angle from the first inflection point to the second inflection point of 45 degrees, 90 degrees, 135 degrees, 180, or 225 degrees.
3. The waveguide of embodiment 1, wherein the first width is equal to the third width.
4. The waveguide of embodiment 1, wherein the adiabatic curve is a first adiabatic curve, the circular arc is a first circular arc, the angle is a first angle, and the first circular arc subtends the first angle in a positive azimuthal direction, and wherein the geometric path further comprises a second adiabatic curve connecting the second inflection point to a third inflection point on the geometric path, the second adiabatic curve comprising: a second circular arc subtending a second angle from a first endpoint to a second endpoint in a negative azimuthal direction, wherein the width of the waveguide is equal to a fourth width along the second circular arc; a second anti-clothoid connecting the second inflection point to the first endpoint of the second circular arc, wherein the width of the waveguide increases from the third width to the fourth width along the second anti-clothoid; and a second clothoid connecting the second endpoint of the second circular arc to the third inflection point, wherein the width of the waveguide decreases from the fourth width to a fifth width along the second clothoid.
5. The waveguide of embodiment 4, wherein the first angle is equal to the second angle, the first width is equal to the fourth width, and the second width is equal to the fifth width.
6. The waveguide of embodiment 5, wherein the geometric path further comprise a first line segment connected to the first inflection point, and a second line segment connected to the third inflection point.
7. The waveguide of embodiment 6, wherein the first and second line segments are parallel to each other.
8. The waveguide of embodiment 4, wherein the fifth width is equal to the third width, and the geometric path further comprises a third adiabatic curve connecting the third inflection point to a fourth inflection point on the geometric path, the third adiabatic curve comprising: a third circular arc subtending the first angle from a first endpoint to a second endpoint in the positive azimuthal direction, wherein the width of the waveguide is equal to the first width along the third circular arc; a third clothoid connecting the third inflection point to the first endpoint of the third circular arc, wherein the width of the waveguide increases from the third width to the first width along the third clothoid; and a third anti-clothoid connecting the second endpoint of the third circular arc to the fourth inflection point, wherein the width of the waveguide decreases from the first width to the second width along the third anti-clothoid.
9. The waveguide of embodiment 8, wherein the geometric path further comprise a first line segment connected to the first inflection point, and a second line segment connected to the fourth inflection point.
10. The waveguide of embodiment 9, wherein the first and second line segments are collinear with each other.
11. An integrated photonic device comprising: a planar surface; a looped waveguide disposed on the planar surface, the looped waveguide having a geometric path defined in the planar surface and a width perpendicular to the geometric path, wherein the geometric path comprises: two adiabatic curves each connecting a respective first inflection point to a respective second inflection point on the geometric path, each adiabatic curve comprising: a respective circular arc subtending an angle from a first endpoint to a second endpoint, wherein the width of the looped waveguide is equal to a first width along the circular arc; a respective clothoid connecting the respective first inflection point to the first endpoint of the circular arc, wherein the width of the looped waveguide increases from a second, different width to the first width along the clothoid; and a respective anti-clothoid connecting the second endpoint of the circular arc to the respective second inflection point, wherein the width of the looped waveguide decreases from the first width to the second width along the anti-clothoid; and two parallel line segments each connecting one of the first inflections points to one of the second inflection points, wherein the width of the looped waveguide is equal to the second width along each of the two parallel line segments; and a bus waveguide disposed on the planar surface and evanescently coupled to the looped waveguide, the bus waveguide being parallel and adjacent to one of the two parallel line segments of the looped waveguide.
12. The integrated photonic device of embodiment 11, wherein the bus waveguide is a first bus waveguide, and the integrated photonic device further comprises: a second bus waveguide disposed on the planar surface and evanescently coupled to the looped waveguide, the second bus waveguide being parallel and adjacent to the other one of the two parallel line segments of the looped waveguide.
13. The integrated photonic device of embodiment 12, wherein the first and second bus waveguides each have the second width.
14. The integrated photonic device of embodiment 11, further comprising: a dielectric layer having the planar surface; and a core layer disposed on the planar surface of the dielectric layer, the core layer comprising the looped and bus waveguides.
15. The integrated photonic device of embodiment 14, further comprising: a ridge layer disposed on the planar surface of the dielectric layer, the ridge layer filling an area enclosed by the looped waveguide and having a smaller height from the planar surface than the core layer.
16. An integrated photonic device comprising: a planar surface; a circular resonator disposed on the planar surface; and a bus waveguide disposed on the planar surface and evanescently coupled to the circular resonator, the bus waveguide having a geometric path defined in the planar surface and a width perpendicular to the geometric path, wherein the geometric path comprises an adiabatic curve connecting a first inflection point to a second inflection point on the geometric path, the adiabatic curve comprising: a circular arc subtending an angle from a first endpoint to a second endpoint about a central point of the circular resonator, wherein the width of the bus waveguide is equal to a first width along the circular arc; a clothoid connecting the first inflection point to the first endpoint of the circular arc, wherein the width of the bus waveguide increases from a second, different width to the first width along the clothoid; and an anti-clothoid connecting the second endpoint of the circular arc to the second inflection point, wherein the width of the bus waveguide decreases from the first width to the second width along the anti-clothoid.
17. The integrated photonic device of embodiment 16, wherein the circular resonator is a ring resonator.
18. The integrated photonic device of embodiment 17, wherein the ring resonator has a radial width equal to the second width.
19. The integrated photonic device of embodiment 16, wherein the circular resonator is a disk resonator.
20. The integrated photonic device of embodiment 19, wherein the disk resonator is composed of a semiconductor, and the disk resonator comprises a dopant dispersed within an annular region of the disk resonator.
21. An integrated photonic device comprising: a planar surface; an elliptical resonator disposed on the planar surface, the elliptical resonator having a semi-major axis, a semi-minor axis, and a center point defined by an intersection of the semi-major and semi-minor axes; and a bus waveguide disposed on the planar surface and evanescently coupled to the elliptical resonator, the bus waveguide having a geometric path defined in the planar surface and a width perpendicular to the geometric path, wherein the geometric path comprises an adiabatic curve connecting a first inflection point to a second inflection point on the geometric path, the adiabatic curve comprising: an elliptical arc subtending an angle from a first endpoint to a second endpoint about the central point of the elliptical resonator, wherein the width of the bus waveguide is equal to a first width along the elliptical arc; a clothoid connecting the first inflection point to the first endpoint of the elliptical arc, wherein the normal width increases from a second, different width to the second width along the clothoid; and an anti-clothoid connecting the second endpoint of the elliptical arc to the second inflection point, wherein the width of the bus waveguide decreases from the auxiliary width to the operational width along the anti-clothoid.
22. An integrated photonic device comprising: a first waveguide having a first geometric path defined in a plane and a width perpendicular to the first geometric path, wherein the first geometric path comprises a first adiabatic curve connecting a first inflection point to a second inflection point on the first geometric path, the first adiabatic curve comprising: a first circular arc subtending an angle from a first endpoint to a second endpoint about a conformal point, wherein the width of the first waveguide is equal to a first width along the first circular arc; a first clothoid connecting the first inflection point on the first geometric path to the first endpoint of the first circular arc, wherein the width of the first waveguide increases from a second width to the first width along the first clothoid; and a first anti-clothoid connecting the second endpoint of the first circular arc to the second inflection point on the first geometric path, wherein the width of the first waveguide decreases from the first width to the second width along the first anti-clothoid; and a second waveguide evanescently coupled to the first waveguide, the second waveguide having a second geometric path defined in the plane and a width perpendicular to the second geometric path, wherein the second geometric path comprises a second adiabatic curve connecting a first inflection point to a second inflection point on the second geometric path, the second adiabatic curve comprising: a second circular arc subtending the angle from a first endpoint to a second endpoint about the conformal point, wherein the width of the second waveguide is equal to a third width along the second circular arc; a second clothoid connecting the first inflection point on the second geometric path to the first endpoint of the second circular arc, wherein the width of the second waveguide increases from a fourth width to the third width along the second clothoid; and a second anti-clothoid connecting the second endpoint of the second circular arc to the second inflection point on the second geometric path, wherein the width of the second waveguide decreases from the third width to the fourth width along the second anti-clothoid.
23. An integrated photonic device comprising: an input waveguide extending along an axis from an input end to an output end, the input waveguide having a width that increases from an input width at the input end to an output width at the output end; a first output waveguide connected to the output end of the input waveguide, the first output waveguide comprising a first adiabatic bend extending from the output end, the first adiabatic bend having positive curvature; and a second output waveguide connected to the output end of the input waveguide, the second output waveguide comprising a second adiabatic bend extending from the output end, the second adiabatic bend having negative curvature.
24. The integrated photonic device of embodiment 23, wherein the first adiabatic bend comprises: a first arcuate section subtending a first angle from a first end to a second end in a positive azimuthal direction; a first Euler section extending from the output end of the input waveguide to the first end of the first arcuate section; and a first anti-Euler section extending from the second end of the first arcuate section, and the second adiabatic comprises: a second arcuate section subtending a second angle from a first end to a second end in a negative azimuthal direction; a second anti-Euler section extending from the output end of the input waveguide to the first end of the second arcuate section; and a second Euler section extending from the second end of the second arcuate section.
25. An integrated photonic device comprising: an input waveguide extending along an axis from an input end to an output end, the input waveguide comprising: a first linear section extending from the input end along the axis, the first linear section having an input width; and a second linear section extending to the output end along the axis, the second linear section having an output width that is larger than the input width; a first output waveguide connected to the output end of the input waveguide, the first output waveguide comprising a first adiabatic bend extending from the output end, the first adiabatic bend having positive curvature; and a second output waveguide connected to the output end of the input waveguide, the second output waveguide comprising a second adiabatic bend extending from the output end, the second adiabatic bend having negative curvature.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

What is claimed is:

1. A waveguide having a geometric path defined in a plane and a width perpendicular to the geometric path,
wherein the geometric path comprises an adiabatic curve connecting a first inflection point to a second inflection point on the geometric path, the adiabatic curve comprising:
a circular arc subtending an angle from a first endpoint to a second endpoint, wherein the width of the waveguide is equal to a first width along the circular arc;
a clothoid connecting the first inflection point to the first endpoint of the circular arc, wherein the width of the waveguide increases from a second, different width to the first width along the clothoid; and
an anti-clothoid connecting the second endpoint of the circular arc to the second inflection point, wherein the width of the waveguide decreases from the first width to a third width along the anti-clothoid.

2. The waveguide of claim 1, wherein the adiabatic curve subtends a bending angle from the first inflection point to the second inflection point of 45 degrees, 90 degrees, 135 degrees, 180, or 225 degrees.

3. The waveguide of claim 1, wherein the first width is equal to the third width.

4. The waveguide of claim 1,
wherein the adiabatic curve is a first adiabatic curve, the circular arc is a first circular arc, the angle is a first angle, and the first circular arc subtends the first angle in a positive azimuthal direction, and
wherein the geometric path further comprises a second adiabatic curve connecting the second inflection point to a third inflection point on the geometric path, the second adiabatic curve comprising:
a second circular arc subtending a second angle from a first endpoint to a second endpoint in a negative azimuthal direction, wherein the width of the waveguide is equal to a fourth width along the second circular arc;
a second anti-clothoid connecting the second inflection point to the first endpoint of the second circular arc, wherein the width of the waveguide increases from the third width to the fourth width along the second anti-clothoid; and
a second clothoid connecting the second endpoint of the second circular arc to the third inflection point, wherein the width of the waveguide decreases from the fourth width to a fifth width along the second clothoid.

5. The waveguide of claim 4, wherein the first angle is equal to the second angle, the first width is equal to the fourth width, and the second width is equal to the fifth width.

6. The waveguide of claim 5, wherein the geometric path further comprise a first line segment connected to the first inflection point, and a second line segment connected to the third inflection point.

7. The waveguide of claim 6, wherein the first and second line segments are parallel to each other.

8. The waveguide of claim 4, wherein the fifth width is equal to the third width, and the geometric path further comprises a third adiabatic curve connecting the third inflection point to a fourth inflection point on the geometric path, the third adiabatic curve comprising:
a third circular arc subtending the first angle from a first endpoint to a second endpoint in the positive azimuthal direction, wherein the width of the waveguide is equal to the first width along the third circular arc;
a third clothoid connecting the third inflection point to the first endpoint of the third circular arc, wherein the width of the waveguide increases from the third width to the first width along the third clothoid; and
a third anti-clothoid connecting the second endpoint of the third circular arc to the fourth inflection point, wherein the width of the waveguide decreases from the first width to the second width along the third anti-clothoid.

9. The waveguide of claim 8, wherein the geometric path further comprise a first line segment connected to the first inflection point, and a second line segment connected to the fourth inflection point.

10. The waveguide of claim 9, wherein the first and second line segments are collinear with each other.

11. An integrated photonic device, comprising:
a planar surface;
a looped waveguide disposed on the planar surface, the looped waveguide having a geometric path defined in the planar surface and a width perpendicular to the geometric path, wherein the geometric path comprises:
two adiabatic curves each connecting a respective first inflection point to a respective second inflection point on the geometric path, each adiabatic curve comprising:
a respective circular arc subtending an angle from a first endpoint to a second endpoint, wherein the width of the looped waveguide is equal to a first width along the circular arc;
a respective clothoid connecting the respective first inflection point to the first endpoint of the circular arc, wherein the width of the looped waveguide increases from a second, different width to the first width along the clothoid; and
a respective anti-clothoid connecting the second endpoint of the circular arc to the respective second inflection point, wherein the width of the looped waveguide decreases from the first width to the second width along the anti-clothoid; and
two parallel line segments each connecting one of the first inflections points to one of the second inflection points, wherein the width of the looped waveguide is equal to the second width along each of the two parallel line segments; and
a bus waveguide disposed on the planar surface and evanescently coupled to the looped waveguide, the bus waveguide being parallel and adjacent to one of the two parallel line segments of the looped waveguide.

12. The integrated photonic device of claim 11, wherein the bus waveguide is a first bus waveguide, and the integrated photonic device further comprises:
a second bus waveguide disposed on the planar surface and evanescently coupled to the looped waveguide, the second bus waveguide being parallel and adjacent to the other one of the two parallel line segments of the looped waveguide.

13. The integrated photonic device of claim 12, wherein the first and second bus waveguides each have the second width.

14. The integrated photonic device of claim 11, further comprising:
a dielectric layer having the planar surface; and
a core layer disposed on the planar surface of the dielectric layer, the core layer comprising the looped and bus waveguides.

15. The integrated photonic device of claim 14, further comprising:
a ridge layer disposed on the planar surface of the dielectric layer, the ridge layer filling an area enclosed by the looped waveguide and having a smaller height from the planar surface than the core layer.

16. An integrated photonic device, comprising:
a planar surface;
a circular resonator disposed on the planar surface; and
a bus waveguide disposed on the planar surface and evanescently coupled to the circular resonator, the bus waveguide having a geometric path defined in the planar surface and a width perpendicular to the geometric path,
wherein the geometric path comprises an adiabatic curve connecting a first inflection point to a second inflection point on the geometric path, the adiabatic curve comprising:
a circular arc subtending an angle from a first endpoint to a second endpoint about a central point of the circular resonator, wherein the width of the bus waveguide is equal to a first width along the circular arc;
a clothoid connecting the first inflection point to the first endpoint of the circular arc, wherein the width of the bus waveguide increases from a second, different width to the first width along the clothoid; and
an anti-clothoid connecting the second endpoint of the circular arc to the second inflection point, wherein the width of the bus waveguide decreases from the first width to the second width along the anti-clothoid.

17. The integrated photonic device of claim 16, wherein the circular resonator is a ring resonator.

18. The integrated photonic device of claim 17, wherein the ring resonator has a radial width equal to the second width.

19. The integrated photonic device of claim 16, wherein the circular resonator is a disk resonator.

20. The integrated photonic device of claim 19, wherein the disk resonator is composed of a semiconductor, and the disk resonator comprises a dopant dispersed within an annular region of the disk resonator.

21. An integrated photonic device, comprising:
a planar surface;
an elliptical resonator disposed on the planar surface, the elliptical resonator having a semi-major axis, a semi-minor axis, and a center point defined by an intersection of the semi-major and semi-minor axes; and
a bus waveguide disposed on the planar surface and evanescently coupled to the elliptical resonator, the bus waveguide having a geometric path defined in the planar surface and a width perpendicular to the geometric path,
wherein the geometric path comprises an adiabatic curve connecting a first inflection point to a second inflection point on the geometric path, the adiabatic curve comprising:
an elliptical arc subtending an angle from a first endpoint to a second endpoint about the central point of the elliptical resonator, wherein the width of the bus waveguide is equal to a first width along the elliptical arc;
a clothoid connecting the first inflection point to the first endpoint of the elliptical arc, wherein the normal width increases from a second, different width to the second width along the clothoid; and
an anti-clothoid connecting the second endpoint of the elliptical arc to the second inflection point, wherein the width of the bus waveguide decreases from the auxiliary width to the operational width along the anti-clothoid.

22. An integrated photonic device, comprising:
a first waveguide having a first geometric path defined in a plane and a width perpendicular to the first geometric path,
wherein the first geometric path comprises a first adiabatic curve connecting a first inflection point to a second inflection point on the first geometric path, the first adiabatic curve comprising:
a first circular arc subtending an angle from a first endpoint to a second endpoint about a conformal point, wherein the width of the first waveguide is equal to a first width along the first circular arc;
a first clothoid connecting the first inflection point on the first geometric path to the first endpoint of the first circular arc, wherein the width of the first waveguide increases from a second width to the first width along the first clothoid; and
a first anti-clothoid connecting the second endpoint of the first circular arc to the second inflection point on the first geometric path, wherein the width of the first waveguide decreases from the first width to the second width along the first anti-clothoid; and
a second waveguide evanescently coupled to the first waveguide, the second waveguide having a second geometric path defined in the plane and a width perpendicular to the second geometric path,
wherein the second geometric path comprises a second adiabatic curve connecting a first inflection point to a second inflection point on the second geometric path, the second adiabatic curve comprising:
a second circular arc subtending the angle from a first endpoint to a second endpoint about the conformal point, wherein the width of the second waveguide is equal to a third width along the second circular arc;
a second clothoid connecting the first inflection point on the second geometric path to the first endpoint of the second circular arc, wherein the width of the second waveguide increases from a fourth width to the third width along the second clothoid; and
a second anti-clothoid connecting the second endpoint of the second circular arc to the second inflection point on the second geometric path, wherein the width of the second waveguide decreases from the third width to the fourth width along the second anti-clothoid.

23. An integrated photonic device, comprising:
an input waveguide extending along an axis from an input end to an output end, the input waveguide having a width that increases from an input width at the input end to an output width at the output end;
a first output waveguide connected to the output end of the input waveguide, the first output waveguide comprising a first adiabatic bend extending from the output end, the first adiabatic bend having positive curvature; and
a second output waveguide connected to the output end of the input waveguide, the second output waveguide comprising a second adiabatic bend extending from the output end, the second adiabatic bend having negative curvature.

24. The integrated photonic device of claim 23, wherein:
the first adiabatic bend comprises:
a first arcuate section subtending a first angle from a first end to a second end in a positive azimuthal direction;
a first Euler section extending from the output end of the input waveguide to the first end of the first arcuate section; and
a first anti-Euler section extending from the second end of the first arcuate section, and
the second adiabatic comprises:
a second arcuate section subtending a second angle from a first end to a second end in a negative azimuthal direction;
a second anti-Euler section extending from the output end of the input waveguide to the first end of the second arcuate section; and
a second Euler section extending from the second end of the second arcuate section.

25. An integrated photonic device, comprising:
an input waveguide extending along an axis from an input end to an output end, the input waveguide comprising:
a first linear section extending from the input end along the axis, the first linear section having an input width; and
a second linear section extending to the output end along the axis, the second linear section having an output width that is larger than the input width;
a first output waveguide connected to the output end of the input waveguide, the first output waveguide comprising a first adiabatic bend extending from the output end, the first adiabatic bend having positive curvature; and
a second output waveguide connected to the output end of the input waveguide, the second output waveguide comprising a second adiabatic bend extending from the output end, the second adiabatic bend having negative curvature.
